(19) United States
(12) Patent Application Publication
(10) Pub. No.: US 2022/0213351 A1
(43) Pub. Date: Jul. 7, 2022

(54) HEAT-TREATED, ORIENTED (CO)POLYMERIC FILMS AND METHODS FOR MAKING THE SAME USING A CROSS-LINKED CARRIER LAYER

(71) Applicant: 3M INNOVATIVE PROPERTIES COMPANY, St. Paul, MN (US)

(72) Inventors: Joel A. Getschel, Osceola, WI (US); Aniruddha A. Upadhye, St. Paul, MN (US); Mark A. Strobel, Maplewood, MN (US); Taylor J. Kobe, Woodbury, MN (US); Steven J. McMan, Stillwater, MN (US); Alan K. Nachtigal, Maplewood, MN (US); Kevin M. Hamer, St. Paul, MN (US)

(21) Appl. No.: 17/595,212

(22) PCT Filed: May 22, 2020
(86) PCT No.: PCT/IB2020/054904

§ 371 Date: Nov. 11, 2021

Related U.S. Application Data
(60) Provisional application No. 62/855,310, filed on May 31, 2019.

(51) Int. Cl. C09J 7/29; C08J 5/18; C08J 7/04; C09J 7/38; C08L 23/12

(52) U.S. Cl. CPC C09J 7/29; C08L 2203/16; C08J 7/0427; C09J 7/38; C08L 23/12; C08J 2323/12; C08J 2367/02; C08J 2433/06; C08J 2451/08; C09J 2423/106; C09J 2467/006; C09J 2433/005; C09J 2301/416; C09J 2301/302; C09J 2301/162; C08J 5/18

(57) ABSTRACT

An oriented heat-treated principal film capable of thermally-induced self-forming, including one or more (co)polymers and exhibiting a relaxation temperature (Tᵣ), the oriented heat-treated principal film having opposed first and second major faces, a land portion on the second major face and one or more modification zones on the second major face. A cross-linked (co)polymeric carrier layer is in contact with the first major face. Each modification zone includes a central closed portion and a rim portion surrounding the central closed portion and being surrounded by a land portion. An average thickness of each rim portion is greater than an average thickness of the land portion surrounding the central closed portion. An average thickness of each central closed portion is less than the average thickness of the land portion surrounding the central portion. Methods for making such films and adhesive articles comprising such films are also disclosed.

### FIELD

The present disclosure relates to heat-treated, oriented (co)polymeric films, related hand-tearable articles (e.g., adhesive tapes and the like) and methods for making and using such films.

### BACKGROUND

Polymeric sheets and films are used in a wide variety of configurations for a wide variety of purposes including as, for example, protective coverings and wraps, drop cloths, the backing member in adhesive tapes and the like.

Especially for sheets and adhesive tapes used in paint masking, it is required that the sheet or adhesive tape be readily torn by hand in order to provide desired degree of hand applicability and utility. Common masking tapes employ paper backings, which despite having been impregnated with saturants and binders to provide water resistance and stretch-ability still exhibit undue moisture sensitivity and are difficult to process with water-based coatings. Such tape backings also exhibit moisture instability such as cockling, buckling and shredding in certain operations such as wet sanding. Other common adhesive tape backings are based on polymer films which, while providing good strength, stretch and water resistance, are often difficult to tear easily by hand. Films based on oriented polymers and especially oriented polyolefins are well known as adhesive tape backings, but usually require the use of a cutting blade or knife in order to be placed into a suitable form for their ultimate use. This is not desirable or of sufficient ease of use for many applications.

It is known that using a process of rapidly heating an oriented polymer film wrapped on a tooled cooling roller can produce open perforations in the film, allowing it to be readily torn by hand (see e.g., U.S. Pat. No. 7,037,100 (Strobel et al.)). It also is known to make oriented precursor films that are capable of thermally-induced elastic recovery during flame perforation. Such perforated oriented films have modification zones comprising a rim portion surrounding a central opening. Because the central openings pass completely through the film, such films are inherently permeable.

### SUMMARY

An unmet need exists for impermeable films and articles incorporating such films (e.g., adhesive tapes) that exhibit good release properties (and thus impart good unwind performance to an adhesive tape made with such films), have good conformability and exhibit hand tear-ability along with other desired mechanical properties.

Briefly, in one aspect, the present disclosure describes a family of films having surprisingly good hand tear-ability, good processability, water resistance, liquid impermeability and conformability. Such films are particularly useful as, for example, protective films and backing films for adhesive tapes and sheets. The present disclosure provides such films, articles made with such films and methods for making such films.

Thus, in one aspect, the present disclosures describes an article including an oriented principal film including one or more (co)polymers and capable of thermally-induced self-forming and exhibiting a relaxation temperature (Tᵣ), the oriented heat-treated principal film having first and second major faces, a land portion on the second major face, one or more modification zones on the second major face and a cross-linked carrier layer in contact with the first major face. Each modification zone comprising a central closed portion and a rim portion surrounding the central closed portion and being surrounded by the land portion. The average thickness of each rim portion is greater than the average thickness of the land portion surrounding the central closed portion. The average thickness of each central closed portion is less than the average thickness of the land portion surrounding the central portion,

The unique set of properties provided by films with this novel configuration makes them well suited for many applications where they can provide many surprising advantages. In some embodiments, the article of the disclosure is used as the backing of an adhesive tape or sheet. In some embodiments, the heat-treated principal film has a tear strength of less than about 100 g_{f}/mil-thickness in the one or more modifications zones.

In another aspect, the present disclosure describes a method for forming a heat-treated principal film, the method including the steps of:
(a) providing an oriented principal film precursor having opposed first and second major faces, the principal film precursor comprising one or more (co)polymers, wherein the principal film precursor is capable of thermally-induced self-forming and exhibits a relaxation temperature (Tᵣ);
(b) forming on the first major face of the principal film precursor a layer of a cross-linkable (co)polymer precursor;
(c) exposing the cross-linkable (co)polymer precursor to a source of actinic or ionizing radiation for a time sufficient to form a cross-linked (co)polymer layer;
(d) overlaying at least one female depression in a patterning surface with at least one modification zone of the principal film precursor and the cross-linked (co)polymer layer;
(e) heating the principle film precursor in the at least one modification zone overlaying the at least one female depression in the patterning surface to a temperature above the Tᵣ, while maintaining a temperature of a land portion on the second major face of the principal film precursor surrounding the at least one modification zone below the Tᵣ, so as to cause dimensional modification of the principal film precursor within the at least one modification zone, thereby forming a heat-treated principal film; and
(f) cooling the at least one modification zone to a temperature below the Tᵣ.

The method yields a heat-treated principal film in which each modification zone includes a central closed portion and a rim portion surrounding the central closed portion and being surrounded by the land portion. The average thickness of each rim portion is greater than the average thickness of the land portion surrounding the modification zone. The average thickness of each central closed portion is less than the average thickness of the land portion surrounding the modification zone.

### Listing of Exemplary Embodiments

A. An article comprising:

an oriented heat-treated principal film comprising one or more (co)polymers, capable of thermally-induced self-forming and exhibiting a relaxation temperature (Tᵣ), the oriented heat-treated principal film having first and second major faces, a land portion and one or more modification zones on the second major face, wherein each modification zone comprising a central closed portion and a rim portion surrounding the central closed portion and being surrounded by the land portion, wherein an average thickness of each rim portion is greater than an average thickness of the land portion surrounding the central closed portion, further wherein an average thickness of each central closed portion is less than the average thickness of the land portion surrounding the central portion; and

a cross-linked carrier layer in contact with the first major face.

B. The article of Embodiment A, wherein the oriented heat-treated principal film has a tear strength of about 70 g_{f}/mil-thickness or less in the one or more modification zones.
C. The article of Embodiment A or B, wherein each rim portion has a geometric shape selected from a circle, an ellipse, or a combination thereof.
D. The article of any one of Embodiments A, B or C, wherein the cross-linked carrier layer comprises a cross-linked (co)polymer.
E. The article of Embodiment D, wherein the cross-linked (co)polymer is obtained by cross-linking one or more multi-functional monomers, oligomers, pre-polymers, or a combination thereof.
F. The article of Embodiment E, wherein the cross-linked (co)polymer comprises a (meth)acrylate (co)polymer.
G. The article of any one of Embodiments A to F, wherein the cross-linked carrier layer has a thickness of from 2 micrometers to 50 micrometers.
H. The article of any preceding Embodiment, wherein the average thickness of the land portion of the heat-treated principal film is about 0.5 to about 3 mils (12 to 75 microns).
I. The article of any preceding Embodiment, wherein the one or more (co)polymers is selected from the group consisting of a polyolefin (co)polymer, a polyester (co)polymer, polystyrene, a polyamide copolymer, or a combination thereof
J. The article of Embodiment K, wherein the polyolefin (co)polymer is selected from the group consisting of biaxially oriented polypropylene (BOPP), simultaneously biaxially oriented polypropylene (SBOPP), ethylene acrylic acid copolymer and combinations thereof.
K. The article of embodiment J, wherein the polyolefin (co)polymer is biaxially oriented polypropylene (BOPP)
L. The article of any preceding Embodiment, wherein the heat-treated principal film is a monolayer or a multilayer.
M. The article of any preceding Embodiment, wherein the heat-treated principal film is heat sealable.
N. The article of any preceding Embodiment, wherein the modification zones are arranged in an ordered array, or in a random manner.
O. The article of any preceding Embodiment, wherein the modification zones have a substantially similar individual configuration, or a varied individual configuration.
P. The article of any preceding Embodiment, wherein the heat-treated principal film has a first segment having a first array of a plurality of modification zones and a second segment having a second array of a plurality of modification zones, wherein the first array differs from the second array in one or more characteristics.
Q. The article of Embodiment P, wherein the characteristics are selected from the group consisting of the following: (1) an average distance between adjacent modification zones, (2) a shape of the modification zones, (3) a dimension of the modification zones and (4) an average thickness of the rim portions.
R. The article of any one of claims Embodiments A to Q, wherein the heat-treated principal film has a first segment having an array of a plurality of modification zones and a second segment which is substantially free of modification zones.
S. The article of any preceding Embodiment, further comprising an adhesive layer on one or both of the cross-linked carrier layer and the second major face of the heat-treated principal film.
T. The article of Embodiment S, wherein the adhesive layer comprises a pressure sensitive adhesive.
U. The article of Embodiment S or T, wherein the adhesive layer is discontinuous.
V. The article of Embodiment S or T, wherein the adhesive layer is substantially continuous.
W. The article of any one of Embodiments S to V, wherein the adhesive layer has an average coating weight of from about 5 to about 100 g/m².
X. The article of any one of Embodiments S to W, wherein the adhesive layer is on only the second major face of the heat-treated principal film and wherein a release coating is on at least a portion of the cross-linked carrier layer opposite the adhesive layer.
Y. The article of Embodiment X, wherein the release coating is on substantially the entire cross-linked carrier layer opposite the adhesive layer.
Z. An article comprising (a) a backing member having front and rear major faces, wherein (a) the article of any one of Embodiments A-R is positioned on the front or rear major face of the backing member and (b) an adhesive layer comprising a pressure sensitive adhesive is at least a portion of the major face of the backing member opposite the article of any one of Embodiments A-R.
AA. The article of Embodiment Z, wherein the backing member comprises a film comprising a (co)polymer selected from the group consisting of a polyolefin (co)polymer, a polyester (co)polymer, polystyrene, a polyamide copolymer, or a combination thereof.
BB. The article of Embodiment Z or AA, wherein the polyester (co)polymer is selected from the group consisting of poly(ethylene)terephthalate, poly(butylene)terephthalate, poly(trimethylene)terephthalate, poly(ethylene)naphthalate, poly(lactic acid) and combinations thereof.
CC. A method for forming an article of any one of Embodiments A-BB, the method comprising the steps of:

(a) providing an oriented heat-treated principal film precursor capable of thermally-induced self-forming and having opposed first and second major faces, the heat-treated principal film precursor comprising one or more (co)polymers and exhibiting a relaxation temperature (Tᵣ);

(b) forming on the first major face of the heat-treated principal film precursor a layer of a cross-linkable (co)polymer precursor;

(c) exposing the cross-linkable (co)polymer precursor to a source of actinic or ionizing radiation for a time sufficient to form a cross-linked (co)polymer layer;

(d) overlaying at least one female depression in a patterning surface with at least one modification zone of the principal film precursor and the cross-linked (co)polymer layer;

(e) heating the principle film precursor in the at least one modification zone overlaying the at least one female depression in the patterning surface to a temperature above the Tᵣ, while maintaining a temperature of a land portion on the second major face of the principal film precursor surrounding the at least one modification zone below the Tᵣ, so as to cause dimensional modification of the principal film precursor within the at least one modification zone, thereby forming a heat-treated principal film; and

(f) cooling the at least one modification zone to a temperature below the Tᵣ, wherein each modification zone of the heat-treated principal film comprises a central closed portion and a rim portion surrounding the central closed portion and being surrounded by the land portion, wherein the average thickness of each rim portion is greater than the average thickness of the land portion surrounding the modification zone, further wherein the average thickness of each central closed portion is less than the average thickness of the land portion surrounding the modification zone.

DD. The method of Embodiment CC, wherein forming comprises vapor coating, solvent-coating, water-based coating, 100% solids coating, or a combination thereof.
EE. The method of Embodiment CC or DD, wherein the source of actinic or ionizing radiation is selected from the group consisting of ultraviolet radiation, infrared radiation, thermal radiation, electron beam radiation, gamma radiation, or a combination thereof.
FF. The method of Embodiment CC, DD or EE, wherein the differential heating is carried out using flame impingement or selectively directed infrared radiation.
GG. The method of Embodiment FF, wherein the differential heating is carried out using flame impingement and the fuel mixture is selected from the group consisting of fuel rich mixtures and fuel lean mixtures.
HH. The method of Embodiment FF, wherein the differentially heating is carried out by selectively directing infrared radiation to the second major face of the principal film precursor while cooling portions of the first major face of the principal film precursor through the cross-linked (co)polymer layer, optionally wherein the principal film precursor on the cross-linked (co)polymer layer is supported on a chill roller during the differential heating, optionally wherein the chill roller has a dimpled surface.
II. The method of any one of Embodiments CC to HH, further comprising applying an adhesive layer on one or both of the cross-linked (co)polymer layer and the second major face of the heat-treated principal film, optionally wherein the adhesive layer comprises a pressure sensitive adhesive.
JJ. The method of any one of Embodiments CC to II, wherein the adhesive layer is on the cross-linked (co)polymer layer, further comprising applying a release coating on at least a portion of the second major face of the heat-treated principal film opposite the adhesive layer, optionally wherein the release coating is on substantially the entire heat-treated principal film surface opposite the adhesive layer.
KK. The method of any one of Embodiments CC to JJ, wherein the (co)polymeric component is selected from the group consisting of a polyolefin (co)polymer, a polyester (co)polymer, polystyrene, a polyamide copolymer, or a combination thereof, optionally wherein the polyolefin (co)polymer is selected from the group consisting of biaxially oriented polypropylene (BOPP), simultaneous biaxially oriented polypropylene (SBOPP), ethylene acrylic acid copolymer and combinations thereof.
LL. The method of any one of Embodiments CC to KK, wherein the cross-linked (co)polymer is obtained by cross-linking one or more multi-functional monomers, oligomers, pre-polymers, or a combination thereof.
MM. The method of Embodiment LL, wherein the cross-linked (co)polymer comprises a (meth)acrylate (co)polymer.

### DESCRIPTION OF THE DRAWINGS

The disclosure may be more completely understood by consideration of the following detailed description of various embodiments of the disclosure in connection with the accompanying figures, in which:

FIG. 1 is a side view of an exemplary process for producing a hand-tearable sheet. according to an exemplary embodiment of the present disclosure;

FIG. 2 is a schematic cross-sectional view of a portion of an illustrative modification zone according to an exemplary a hand-tearable sheet embodiment of the present disclosure;

FIG. 3 is a plan view of the first major face of an illustrative embodiment of a hand-tearable sheet produced according to the method of the present disclosure;

FIG. 4 is a schematic cross-sectional view of a portion of an illustrative modification zone in accordance with one embodiment of the method of the present disclosure;

FIG. 5A is a perspective view of an illustrative embodiment of a roller of adhesive tape of the disclosure;

FIG. 6A is a top view of a portion of the surface of the adhesive tape shown in FIG. 5A;

FIG. 6B is a top view of a portion of the surface of another embodiment of an adhesive tape in accordance with another embodiment of the present disclosure;

FIGS. 7A, 7B and 7C are optical microscope photographs of portions of the surfaces of flame perforated films according to embodiments of the present disclosure;

FIGS. 8A, 8B and 8C are photographs of portions of the surfaces of flame perforated films according to embodiments of the present disclosure

In the drawings, like reference numerals indicate like elements. While the above-identified drawing, which may not be drawn to scale, sets forth various embodiments of the present disclosure, other embodiments are also contemplated, as noted in the Detailed Description. In all cases, this disclosure describes the presently disclosed disclosure by way of representation of exemplary embodiments and not by express limitations. It should be understood that numerous other modifications and embodiments can be devised by those skilled in the art, which fall within the scope and spirit of this disclosure.

### DETAILED DESCRIPTION

For the following Glossary of defined terms, these definitions shall be applied for the entire application, unless a different definition is provided in the claims or elsewhere in the specification.

### Glossary

Certain terms are used throughout the description and the claims that, while for the most part are well known, may require some explanation. It should understood that:

The term “homogeneous” means exhibiting only a single phase of matter when observed at a macroscopic scale.

The terms “(co)polymer” or “(co)polymers” includes homopolymers and copolymers, as well as homopolymers or copolymers that may be formed in a miscible blend, e.g., by coextrusion or by reaction, including, e.g., transesterification. The term “copolymer” includes random, block and star (e.g., dendritic) copolymers.

The term “cross-linked (co)polymer” refers to a (co)polymer whose molecular chains are joined together by covalent chemical bonds, usually via cross-linking molecules or groups, to form a network (co)polymer. A cross-linked (co)polymer is generally characterized by insolubility, but may be swellable in the presence of an appropriate solvent.

The term “cross-linker” is synonymous with the term “cross-linkable (co)polymerizable compound,” which upon ultraviolet (UV) light, electron beam or gamma irradiation, becomes excited to a higher energy state to form a radical, often a multi-functional radical, which can undergo cross-linking. In some cases, radicals may be formed by abstracting a hydrogen atom from a (meth)acrylate base (co)polymer engaging in free radical polymerization, or alternatively, a hydrogen-donating molecule engaging in a Norrish type II reaction thereby generating a free radical capable of further reaction, such as e.g. free radical addition polymerization, free radical addition cross-linking, and the like.

The term “(meth)acrylate” with respect to a monomer, oligomer or means a vinyl-functional alkyl ester formed as the reaction product of an alcohol with an acrylic or a methacrylic acid.

The terms “differential heating” and “localized heating” mean heating the principal film such that the temperature of select portions of the principal film (i.e., in an x-y perspective across the film) is raised to a level higher than the temperature of adjacent portions of the principal film. Such heating may be carried out by such means as flame impingement (e.g., as described in U.S. Pat. No. 7,037,100), selective directed infrared radiation and the like

The terms “orientable” or “oriented” means that the (co)polymer material, if heated above a certain temperature (Tₒ or orientation temperature) and drawn, will undergo shifting and orientation of polymer segments therein and then if cooled below Tₒ, will retain some of the imparted orientation when subsequently released. The temperature at which a specific (co)polymer film may be oriented will depend in part upon the distribution of segments of polymer materials within the film and respective melting points of components fractions in the film.

The equivalent terms “thermally-induced elastic recovery” and “thermally-induced self-forming” refer to the action or response whereby a member or body of material, upon being heated to a threshold temperature (referred to herein as Tᵣ or relaxation temperature), spontaneously changes its shape or configuration, without application of external mechanical form-changing forces (e.g., gravity, embossing, molding and the like) or without undergoing material removal effects (e.g., mechanical etching, ablation such as by laser, combustion, evaporation and the like).

The term “flame impingement” refers to a process for heating a principal film precursor wherein a heat flux in the form of a flame is directed to a first major face of a film. An illustrative example is disclosed in U.S. Pat. No. 7,037,100 (Strobel et al.).

Flame properties are commonly correlated with the molar ratio of oxidizer to fuel. The exact ratio of oxidizer to fuel needed for complete combustion is known as the stoichiometric ratio.

The equivalence ratio is defined as the stoichiometric oxidizer/fuel ratio divided by the actual oxidizer/fuel ratio. For “fuel-lean”, or oxidizing, flames there is more than the stoichiometric amount of oxidizer and so the flame equivalence ratio is less than one. For “fuel-rich” flames, there is less than the stoichiometric amount of oxidizer present in the combustible mixture and thus the equivalence ratio is greater than one.

The term “adjoining” with reference to a particular layer means joined with or attached to another layer, in a position wherein the two layers are either next to (i.e., adjacent to) and directly contacting each other, or contiguous with each other but not in direct contact (i.e., there are one or more additional layers intervening between the layers).

By using terms of orientation such as “atop”, “on”, “over,” “covering”, “uppermost”, “underlying” and the like for the location of various elements in the disclosed coated articles, we refer to the relative position of an element with respect to a horizontally-disposed, upwardly-facing substrate. However, unless otherwise indicated, it is not intended that the substrate or articles should have any particular orientation in space during or after manufacture. For purposes of clarity and without intending to be unduly limited thereby, the tape sheets or strips in a group of any two sequentially stacked sheets or strips are referenced as an overlying tape sheet and an underlying tape sheet with the adhesive layer of the overlying tape sheet adhered to the front or first face of the backing of the underlying tape sheet.

By using the term “overcoated” to describe the position of a layer with respect to a substrate or other element of an article of the present disclosure, we refer to the layer as being atop the substrate or other element, but not necessarily contiguous to either the substrate or the other element.

By using the term “separated by” to describe the position of a layer with respect to other layers, we refer to the layer as being positioned between two other layers but not necessarily contiguous to or adjacent to either layer.

The terms “about” or “approximately” with reference to a numerical value or a shape means +/−five percent of the numerical value or property or characteristic, but expressly includes the exact numerical value. For example, a viscosity of “about” 1 Pa-sec refers to a viscosity from 0.95 to 1.05 Pa-sec, but also expressly includes a viscosity of exactly 1 Pa-sec. Similarly, a perimeter that is “substantially square” is intended to describe a geometric shape having four lateral edges in which each lateral edge has a length which is from 95% to 105% of the length of any other lateral edge, but which also includes a geometric shape in which each lateral edge has exactly the same length.

The term “substantially” with reference to a property or characteristic means that the property or characteristic is exhibited to a greater extent than the opposite of that property or characteristic is exhibited. For example, a substrate that is “substantially” transparent refers to a substrate that transmits more radiation (e.g., visible light) than it fails to transmit (e.g., absorbs and reflects). Thus, a substrate that transmits more than 50% of the visible light incident upon its surface is substantially transparent, but a substrate that transmits 50% or less of the visible light incident upon its surface is not substantially transparent.

As used in this specification and the appended embodiments, the singular forms “a”, “an” and “the” include plural referents unless the content clearly dictates otherwise. Thus, for example, reference to fine fibers containing “a compound” includes a mixture of two or more compounds. As used in this specification and the appended embodiments, the term “or” is generally employed in its sense including “and/or” unless the content clearly dictates otherwise.

As used in this specification, the recitation of numerical ranges by endpoints includes all numbers subsumed within that range (e.g., 1 to 5 includes 1, 1.5, 2, 2.75, 3, 3.8, 4 and 5).

Unless otherwise noted, all parts, percentages, ratios and the like used in the specification are expressed based on the weight of the ingredients. Weight percent, percent by weight, % by weight, wt. % and the like are synonyms that refer to the amount of a substance in a composition expressed as the weight of that substance divided by the weight of the composition and multiplied by 100.

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least and not as an attempt to limit the application of the doctrine of equivalents to the scope of the claimed embodiments, each numerical parameter should at least be construed in light of the number of reported significant digits and by applying ordinary rounding techniques.

Exemplary embodiments of the present disclosure may take on various modifications and alterations without departing from the spirit and scope of the present disclosure. Accordingly, it is to be understood that the embodiments of the present disclosure are not to be limited to the following described exemplary embodiments but is to be controlled by the limitations set forth in the claims and any equivalents thereof.

Various exemplary embodiments of the disclosure will now be described with particular reference to the Drawings. Exemplary embodiments of the present disclosure may take on various modifications and alterations without departing from the spirit and scope of the disclosure. Accordingly, it is to be understood that the embodiments of the present disclosure are not to be limited to the following described exemplary embodiments, but are to be controlled by the limitations set forth in the claims and any equivalents thereof.

### Apparatus

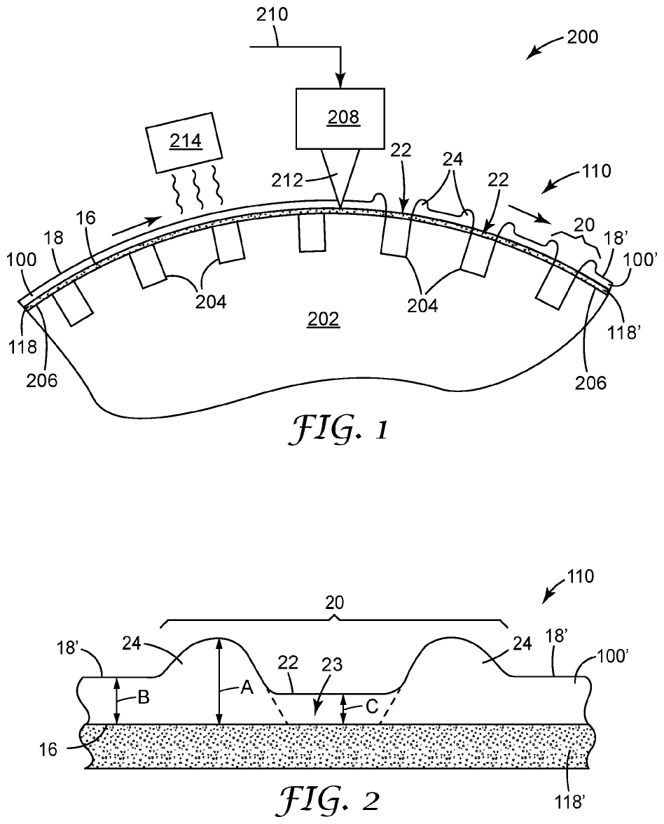

FIG. 1 illustrates an exemplary apparatus 200 for producing films according to the present disclosure. A principal film precursor 100 having first and second major faces 16 and 18 is positioned on and contacting a cross-linkable layer 118. Major face 16 of the principal film precursor 100 contacts the cross-linkable layer 118, which has a lower major surface 206 which is is positioned in contact with a chilled back-up roller 202 bearing a pattern of female depressions 204.

The principal film precursor 100 on the cross-linkable layer 118 is passed under a radiation curing source 214 which acts to cross-link the cross-linkable layer 118. The principal film precursor 100 on the now cross-linked layer 118′ is passed under a flame 212 created by flowing a combustion gas mixture 210 through a flame ribbon burner 208 to form a heat-treated principal film precursor 100′ on the cross-linked layer 118′ and thereby form a heat-treated principal film 110. The principal film precursor 100 is exposed to the flame 212 for a time sufficient to create one or more modification zones 20 formed as a thin central portion 22, surrounded by a rim portion 24, thereby producing the heat-treated principal film 110. A land portion 14 (see FIG. 3) formed by heat-treated top surface 18′ of the heat-treated principal film precursor 100′ that adjoins the rim portion 24.

Any suitable radiation curing source 214 may be advantageously selected. Suitable radiation curing sources include sources of actinic radiation such as ultraviolet light sources (e.g., light-emitting diodes, germicidal lamps or fluorescent light bulbs), visible light sources and infrared light sources; or sources of ionizing radiation, such as electron beam radiation and ionizing radiation (e.g., gamma radiation) curing sources. Exemplary radiation curing sources are described, for example, in U.S. Pat. Nos. 6,040,352; 6,866,899; 8,822,560; 9,534,133; 9,580,631 and 9,708,514.

Alternatively or additionally, thermal curing may be advantageously used to achieve cross-linking, for example, using an oven, a forced gas flow convection heating system, a heated roller, infrared heating, or the like. Suitable forced gas flow convection heating systems may be obtained from Roberts-Gordon, LLC (Buffalo, N.Y.); Applied Thermal Systems, Inc. (Chattanooga, Tenn.); and from Chromalox Precision Heat and Control (Pittsburgh, Pa.). Suitable radiant infrared heating systems may be obtained from Research, Inc. of Eden Prairie, Minn.; Infrared Heating Technologies, LLC (Oak Ridge, Tenn.); and Roberts-Gordon, LLC (Buffalo, N.Y.).

### Processes for Heat Treatment to form Hand-tearable Films

Referring to FIGS. 1-4, processes of the present disclosure can make use of various film forming, orientation and heat-treating apparatus 200 and techniques that provide heat-treatment to oriented principal film precursors 100 to produce heat-treated oriented principal films 100′ including one or more modification zones 20 with rims 24 and thin recessed central portions 22, positioned on a cross-linked layer 118′, as described herein. Exemplary heat-treating methods of the present disclosure include
(a) providing an oriented principal film precursor capable of thermally-induced self-forming and having opposed first and second major faces, the principal film precursor comprising one or more (co)polymers and exhibiting a relaxation temperature (Tᵣ);
(b) forming on the first major face of the principal film precursor a layer of a cross-linkable (co)polymer precursor;
(c) exposing the cross-linkable (co)polymer precursor to a source of actinic or ionizing radiation for a time sufficient to form a cross-linked (co)polymer layer;
(d) overlaying at least one female depression in a patterning surface with at least one modification zone of the principal film precursor and the cross-linked (co)polymer layer;
(e) heating the principle film precursor in the at least one modification zone overlaying the at least one female depression in the patterning surface to a temperature above the Tᵣ, while maintaining a temperature of a land portion on the second major face of the principal film precursor surrounding the at least one modification zone below the Tᵣ, so as to cause dimensional modification of the principal film precursor within the at least one modification zone, thereby forming a heat-treated principal film; and
(f) cooling the at least one modification zone to a temperature below the Tᵣ,.

FIG. 2 shows a cross section of an exemplary modification zone 20 for an exemplary embodiment of a heat-treated principal film 110 of the present disclosure. A cross-linked layer 118′ is positioned in contact with major face 16 of the heat-treated principal film precursor 100′. A land portion (see 14 in FIG. 3) formed by top surface 18′ of the heat-treated principal film precursor 100′ defines the modification zone 20 in terms of a thin central portion 22 (which may have zero thickness as indicated by 23) surrounded by a rim portion 24.

As shown in FIG. 2, the heat-treating method yields a heat-treated principal film 110 in which each modification zone 20 includes a central closed portion 22 and a rim portion 24 surrounding the central closed portion 22 and being surrounded by the land portion 14 formed by top surface 18′ of the heat-treated principal film precursor 100′. The average thickness of each rim portion is greater than the average thickness of the land portion surrounding the modification zone. The average thickness of each central closed portion is less than the average thickness of the land portion surrounding the modification zone.

In accordance with the disclosure, land portion 14 surrounds rim portion 24 surrounding central portion 22. The average thickness of rim portion 24 (dimension B) is greater than the average thickness of land portion 14 (dimension A) which in turn is greater than the average thickness of central portion 22 (dimension C). Though the profile of thickness of central portion 22 may be curved (i.e., one or both of major faces 16 and 18 may be contoured throughout central portion 22 rather than being flat as shown), dimension C is greater than zero throughout the central portion 22. The modification zone of films of this embodiment of the disclosure is impermeable rather than having through channels such as are found in previously known films formed via flame impingement. It is not necessary for each of the modification zones to be wholly identical to the others or absolutely precise in shape, size, or thickness.

Many techniques and apparatus known in the art for flame perforation can be employed in the present disclosure. As they do when used for conventional flame perforation, when used to form modification zones in accordance with the present disclosure, such techniques and apparatus will yield heat-treated principal films having modification zones that vary somewhat in size and perfection of shape. This does not have a significant deleterious effect on the practice of embodiments of the present disclosure.

The method and process conditions used to carry out formation of modification zones are selected in part based upon the desired modification zones and nature of the films. It is typically preferred that the process be carried out so as to minimize the degree of thermal damage the film undergoes aside from formation of the desired modification zones.

Heating to create at least one modification zone 20 in the heat-treated principal film 110, may be carried out using a variety of methods. In some exemplary embodiments, heating is carried out using flame impingement or selectively directed infrared radiation on a major face of the principal film precursor. Preferably, the oriented principal film precursor 100 on the principal film precursor 118 overlaying the at least one female depression 204 is passed under a flame 212 created by flowing a combustion gas mixture 210 through a flame ribbon burner 208. Preferably, heating is carried out using flame impingement on the external major face of the principal film precursor and the fuel mixture is selected from the group consisting of fuel rich mixtures and fuel lean mixtures, as described further below. The outer surface 18 of the oriented principal film precursor 100 on the principal film precursor 118 overlaying the at least one female depression 204 is preferably exposed to the flame 212.

Passing the web through the flame impingement station at higher speed results in formation of relatively smaller modification zones. As will be understood by those skilled in the art, other flame impingement conditions used (such as the flame power, the burner-to-film separation, or backing roller patterns) can be adjusted to attain similar modification zone sizes and spacing or any desired array of modification zones.

In other exemplary embodiments, heating is carried out by applying radiant infrared energy to the exposed (i.e., second) major face of the principal film precursor while cooling portions of an opposed (i.e., first) major face of the principal film precursor overlaying at least one female depression 204 in the patterning surface 202.

The pattern of depressions (sometimes referred to as indentations, wells, or dimples) in the backing roller that are used to achieve the desired differential heating determines in part the arrangement and dimensions of the resultant modification zones with each modification zone corresponding to a dimple or depression in the backing roller. In some instances, the modification zones are arranged in an ordered array. In some instances, the modification zones are arranged in a random manner. If desired, the modification zones may have substantially similar individual configuration (i.e., from using backing rollers with depressions that are substantially in shape and dimension), or the modification zones may have varied individual configuration (i.e., from using backing rollers having depressions that vary accordingly in shape, dimension, or both).

In any of the foregoing embodiments, the patterning surface 202 may be a roller comprising a major face having a plurality of the female depressions 204, as shown in FIG. 1. Preferably the roller is a chill roller, that is, a roller maintained at a temperature less than the temperature of the principal film 118 in order to effect cooling of the principal film 118 to a temperature below the heat-treatment temperature. The surface temperature of the chill roller may advantageously be maintained at a temperature of from 0° C. to 30° C., more preferably 5° C. to 25° C., 10° C. to 20° C., or any combination thereof. Preferably, the surface of the chill roller is maintained at a temperature above the dew point of water vapor to avoid water condensation on the surface of the chill roller.

In some exemplary embodiments, each rim portion has a geometric shape selected from a circle, an ellipse, or a combination thereof Furthermore, it is not necessary for each of the modification zones to be wholly identical to the others or absolutely precise in shape, size, or thickness. Many techniques and apparatus known in the art for flame treatment can be employed in the present disclosure. As they do when used for conventional differential flame treating, when used to form modification zones in accordance with the disclosure, such techniques and apparatus will yield heat-treated principal films having modification zones that vary somewhat in size and perfection of shape, but which nevertheless are hand-tearable.

Certain surprising aspects of the present disclosure are more easily achieved with an understanding of the effective equivalence ratio used in flame impingement heat-treating processes and effective exploitation thereof.

In a fuel-rich flame, the overall environment in which the film is exposed to the flame is primarily reducing in nature because of the high concentration of hydrogen atoms, carbon monoxide and hydrocarbon free radicals, yet some oxidation of the film occurs because there are some oxidizing species still present in the flame product gases. In contrast, in a fuel-lean flame such as is taught in the art for the surface treatment of (co)polymers to impart higher adhesion properties thereto, the overall environment is highly oxidizing because of the high concentrations of oxygen molecules and hydroxyl radicals.

Flame impingement to carry out differential heating and modification of the heat-treated principal film in accordance with the disclosure requires relatively high flame powers to modify and differentially heat the (co)polymer film at commercially desirable film speeds. For example, flame powers of at least about 10,000 Btu/hr per inch of cross-web burner length (1160 Watts/cm) are typically desirable to enable differential heating at speeds of from about 20 to over 100 meters/min. When using the fuel-lean flames that are taught in the art as optimal for the flame processing of (co)polymers, such conditions of high flame power and relatively low film speed cause significant oxidation of the (co)polymer surface. When a (co)polymer surface is relatively highly oxidized, adhesion to that surface is typically high. Thus, if a fuel-lean flame is used for flame impingement, the resulting rims are oxidized to such an extent that the pressure-sensitive adhesives tend to adhere more strongly to the rims, thereby interfering with and in some instances preventing unwind of the tape. We have found that undesired oxidation of the (co)polymer rim surface can be limited by using low-power fuel-lean flames (for example, at powers of less than about 5000 Btu/hr-in.). However, when using such low-power flames, it is not possible to effectively modify the film at commercially viable film speeds.

It is surprising that fuel-rich flames can be used at sufficiently high powers to enable differential heating sufficient to achieve desired thermally-induced self-forming at film speeds of more than about 20 meters/min, but without causing the excessive oxidation of the rims that might prevent smooth and easy unwinding of, for instance, finished tape made with such heat-treated principal films.

The method and process conditions used to carry out formation of modification zones are selected in part based upon the desired modification zones and nature of the films. It is typically preferred that the process be carried out so as to minimize the degree of thermal damage the film undergoes aside from formation of the desired modification zones.

Passing the web through the flame impingement station at higher speed generally results in formation of relatively smaller modification zones. As will be understood by those skilled in the art, other flame impingement conditions used (such as the flame power, the burner-to-film separation, or backing roller patterns) can be adjusted to attain similar modification zone sizes and spacing or any desired array of modification zones.

The pattern of female depressions (sometimes referred to as indentations, wells, or dimples) in the backing roller that are used to achieve the desired differential heating determines in part the arrangement and dimensions of the resultant modification zones with each modification zone corresponding to a dimple or depression in the backing roller. In some instances, the modification zones are arranged in an ordered array. In some instances, the modification zones are arranged in a random manner. If desired, the modification zones may have substantially similar individual configuration (i.e., from using backing rollers with female depressions that are substantially similar in shape and dimension), or the modification zones may have varied individual configuration (i.e., from using backing rollers having depressions that vary accordingly in shape, dimension, or both).

Flame impingement heat treating can be performed, for example, using the apparatus and the process given for Example 1 of U.S. Pat. No. 7,037,100. Such apparatus ordinarily employs premixed laminar flames in which the fuel and the oxidizer are thoroughly mixed prior to combustion. However, in contrast to the process described in U.S. Pat. No. 7,037,100, in some embodiments of the present disclosure a fuel-rich flame is used. According to the properties desired of the resultant film, the flame impingement process may be carried out so as to impart desired surface characteristics (e.g., using a relatively fuel rich mix when increased release tendencies are desired (e.g., to achieve release with reduced or eliminated release agent) as opposed to using a relatively fuel lean mix when increased bonding tendencies are desired).

As shown schematically in FIG. 1, the major face 18 of the oriented principal film precursor 100 that is exposed to the flame during formation of the modification zones 20 generally develops the rims 24 of (co)polymer material that surround the closed central portion 22. However, a rim may also form in that portion of the heat-treated principal film precursor 100′ that underlies each rim 24 formed in each modification zone 20. Furthermore, in some exemplary embodiments, the rim portion 24 of the modification zone 20 may be made up of protrusion of the film outwardly (i.e., z-axis) from any or all of major face 18′ of the heat-treated oriented principal film precursor 100′ of the heat-treated principal film 110, and major face 16′ of the heat-treated principal film precursor 100 overlaying cross-linked layer 118′.

In certain embodiments, rims may effectively act as the release surface for an adhesive subsequently applied to the opposite side by minimizing the contact between the backing member and the adhesive when wound into the common roller form of tape. In instances where it is important that the rim surface exhibit release properties, it is critical that the process for formation of modification zones be performed by using flame conditions that do not overly oxidize the first major face of the film in either the raised rims or surrounding land portion; that is, by using flame conditions that minimize the adhesion-promoting characteristics of the surface oxidation typically caused by exposure to a flame.

While flame-induced surface oxidation cannot be totally eliminated, oxidation is maximized at a flame equivalence ratio of 0.92 to 0.96, but minimized at flame equivalence ratios of at least about 1.05, which are fuel-rich flames [See C. Stroud et al., Progress in Energy and Combustion Science, 34 (6), 696-713 (2008)]. It is therefore necessary to conduct the flame impingement process using a fuel-rich flame, preferably with an equivalence ratio of about 1 and preferably at least about 1.05. Use of fuel-rich flames for flame perforating cast (co)polymer films is contrary to essentially all recommendations in the art of flame treating. The advantages obtained from suing such backing members, e.g., improvement in unwind in the tape roller form is good, resistance to paint penetration and the like are surprising outcomes from this processing choice.

It is known from the relevant art (e.g., from U.S. Pat. No. 7,037,100 and the like) that oriented (co)polymeric films can be exposed to a high heat flux source such as a flame while wrapped on a cooled tooled backing roller, causing differential heating of the two major faces. It is thought that the exposure of the film sections directly spanning a tooled indentation in the cooled backing roller causes a very rapid heating of that film section which causes a sudden, uncontrolled release or relaxation of the film orientation and results in a perforation being formed with associated ‘rim’ material at the margins of the modification zone, comprising the mass of relaxed (co)polymer molecules caused by this shrinkage. This process is termed thermally induced elastic recovery, or thermally-induced self-forming. The present disclosure relates to the surprising discovery that, by using principal film precursors such as a described herein, modification zones with closed central portions can be formed rather than modification zones with only open perforations as was previously known.

### Materials

Cross-Linkable Layers

Any suitable cross-linkable material may be used to form the cross-linkable layer. Suitable materials include ethylenically-unsaturated multi-functional monomers, oligomers, or pre-polymers. Particularly suitable cross-linkable materials include (meth)acrylic monomers, oligomers, or pre-polymers (i.e., macromers), polyesters, epoxies, polyurethanes. The ethylenically-unsaturated materials suitable for use in practicing exemplary methods of the present disclosure are generally selected from vinyl-functional monomers, vinyl-functional oligomers, vinyl-functional macromers, and combinations thereof.

Vinyl-Functional Monomers

A variety of free radically (co)polymerizable monomers can be used according to the method of the present disclosure. Thus, in some exemplary embodiments, the free radically (co)polymerizable ethylenically-unsaturated material is comprised of vinyl-functional monomers, more preferably, vinyl-functional (meth)acrylate monomers.

The identity and relative amounts of such components are well known to those skilled in the art. Particularly preferred among (meth)acrylate monomers are alkyl (meth)acrylates, preferably a monofunctional unsaturated acrylate ester of a non-tertiary alkyl alcohol, wherein the alkyl group contains 1 to about 30 carbon atoms, more preferably 1 to 18 carbon atoms. Included within this class of monomers are, for example, isooctyl acrylate, isononyl acrylate, 2-ethylhexyl acrylate, decyl acrylate, dodecyl acrylate, n-butyl acrylate, hexyl acrylate, octadecyl acrylate, 2-methyl butyl acrylate, and mixtures thereof.

In some presently preferred embodiments, the monofunctional unsaturated (meth)acrylate esters of a non-tertiary alkyl alcohol are selected from the group consisting of isooctyl acrylate, isononyl acrylate, 2-ethylhexyl acrylate, 2-octyl acrylate, 3-octyl acrylate, 4-octyl acrylate, decyl acrylate, dodecyl acrylate, n-butyl acrylate, hexyl acrylate, octadecyl acrylate, methyl acrylate, ethyl acrylate, butyl acrylate, methyl methacrylate, N-butyl methacrylate, 2-methyl butyl acrylate, and mixtures thereof.

In certain exemplary embodiments, the free radically (co)polymerizable ethylenically-unsaturated monomers are comprised of difficult to (co)polymerize monomers selected from N-vinyl pyrrolidone, N,N-dimethyl acrylamide, (meth)acrylic acid, acrylamide, N-octyl acrylamide, styrene, vinyl acetate, and combinations thereof.

Optionally and preferably in preparing a PSA, polar (co)polymerizable monomers can be (co)polymerized with the (meth)acrylate monomers to improve adhesion of the final adhesive composition to metals and also improve cohesion in the final adhesive composition. Strongly polar and moderately polar (co)polymerizable monomers can be used.

Strongly polar (co)polymerizable monomers include but are not limited to these selected from the group consisting of (meth)acrylic acid, itaconic acid, hydroxyalkyl acrylates, cyanoalkyl acrylates, acrylamides, substituted acrylamides, and mixtures thereof. A strongly polar (co)polymerizable monomer preferably constitutes a minor amount, for example, up to about 25 weight % of the monomer, more preferably up to about 15 weight %, of the monomer mixture.

When strongly polar (co)polymerizable monomers are present, the alkyl acrylate monomer generally constitutes a major amount of the monomers in the acrylate-containing mixture, for example, at least about 75% by weight of the monomers.

Moderately polar (co)polymerizable monomers include, but are not limited to, those selected from the group consisting of N-vinyl pyrrolidone, N,N-dimethyl acrylamide, acrylonitrile, vinyl chloride, diallyl phthalate, and mixtures thereof. A moderately polar (co)polymerizable monomer preferably constitutes a minor amount, for example, up to about 40 weight %, more preferably from about 5 weight % to about 40 weight %, of the monomer mixture. When moderately polar (co)polymerizable monomers are present, the alkyl acrylate monomer generally constitutes at least about 60 weight % of the monomer mixture.

Vinyl-Functional Oligomers and Macromers

Macromonomers (macromers) are another ethylenically-unsaturated material useful in certain embodiments of the present disclosure. Described in U.S. Pat. No. 4,732,808 is the use of free-radically (co)polymerizable macromonomers having the general formula X—(Y)ₙ—Z wherein:
X is a vinyl group (co)polymerizable with other monomer(s) in the reaction mixture;
Y is a divalent linking group; where n can be zero or one; and
Z is a monovalent (co)polymeric moiety having a glass transition temperature, T_{g}, greater than about 20° C., and a weight average molecular weight in the range of about 2,000 to about 30,000 and being essentially unreactive under thermally initiated (co)polymerization conditions.

These macromonomers are generally used in mixtures with other (co)polymerizable monomer(s). A preferred macromonomer described in U.S. Pat. No. 4,732,808 can be further defined as having an X group which has the general formula:

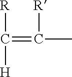

wherein R is a hydrogen atom or a —COOH group and R′ is a hydrogen atom or methyl group. The double bond between the carbon atoms provides a (co)polymerizable moiety capable of (co)polymerizing with the other monomer(s) in the reaction mixture.

A preferred macromonomer includes a Z group which has the general formula:

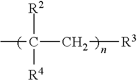

wherein R² is a hydrogen atom or a lower alkyl group (typically C₁ to C₄), R³ is a lower alkyl group (typically C₁ to C₄), n is an integer from 20 to 500 and R⁴ is a monovalent radical selected from the group consisting of:

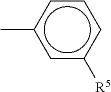

and —CO₂R⁶ wherein R⁵ is a hydrogen atom or a lower alkyl group (typically C₁ to C₄) and R⁶ is a lower alkyl group (typically C₁ to C₄).

Preferably, the macromonomer has a general formula selected from the group consisting of:

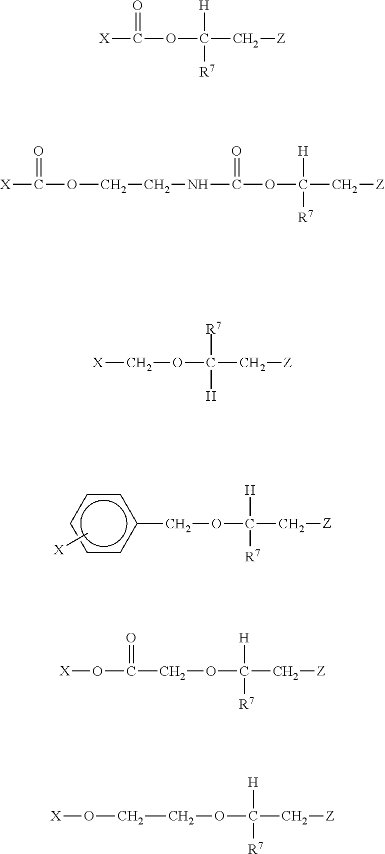

wherein R⁷ is a hydrogen atom or lower alkyl group (typically C₁ to C₄).

Preferred macromonomers are functionally terminated (co)polymers having a single functional group (the vinyl group) and are sometimes identified as “semitelechelic” (co)polymers. (Vol. 27 “Functionally Terminal Polymers via Anionic Methods” D. N. Schultz et al., pages 427-440, Anionic Polymerization, American Chemical Society [1981]). Such macromonomers are known and may be prepared by the methods disclosed by Milkovich et al. in U.S. Pat. Nos. 3,786,116 and 3,842,059. As disclosed therein, vinyl terminated macromonomer is prepared by anionic (co)polymerization of (co)polymerizable monomer to form a living (co)polymer. Such monomers include those having an olefinic group, such as the vinyl-containing compounds. Living (co)polymers are conveniently prepared by contacting the monomer with an alkali metal hydrocarbon or alkoxide salt in the presence of an inert organic solvent which does not participate in or interfere with the (co)polymerization process. Monomers which are susceptible to anionic (co)polymerization are well known. Illustrative species include vinyl aromatic compounds such as styrene, alpha-methyl styrene, vinyl toluene and its isomers or non-aromatic vinyl compounds such as methyl methacrylate. Other monomers susceptible to anionic (co)polymerization are also useful.

The purpose of using a (co)polymerizable macromonomer includes but is not limited to enabling hot-melt coating of the cross-linkable layer onto a major face of the principal film precursor. The amount of macromonomer used is generally within the range of about 1% to about 30%, preferably about 1% to about 7%, of the total weight of monomers. The optional use of such macromonomers is included within the scope of the present disclosure. A particular advantage of some exemplary embodiments of the present disclosure is the ability to successfully (co)polymerize said macromonomers into the (co)polymer backbone.

Optional Cross-Linker(s)

One or more cross-linker(s) may be used in forming the cross-linkable layer. Examples of suitable cross-linking agents or cross-linkers include but are not limited to those selected from the groups consisting of hydrogen abstraction type photo-cross-linkers such as those based on benzophenones, acetophenones, anthraquinones, and the like. These cross-linking agents can be (co)polymerizable or non-(co)polymerizable.

Examples of suitable non-(co)polymerizable hydrogen abstraction cross-linking agents include benzophenone, anthraquinones, and radiation-activatable cross-linking agents such as those described in U.S. Pat. No. 5,407,971. Such agents have the general formula:

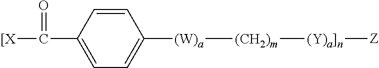

wherein W represents —O—, —N—, or —S—; X represents CH₃— or phenyl; Y represents a ketone, ester, or amide functionality; Z represents a polyfunctional organic segment that contains no hydrogen atoms more photo-abstractable than hydrogen atoms of a (co)polymer formed using the cross-linking agent; m represents an integer from 0 to 6; “a” represents 0 or 1; and n represents an integer 2 or greater. Depending on the amount of cross-linking desired and the efficiency of the particular cross-linker used, non-(co)polymerizable cross-linking agents are typically included in the amount of about 0% to about 10%, and preferred in the range of about 0.05% to about 2%, based on the total weight of the ethylenically-unsaturated material (e.g. monomers).

Examples of suitable (co)polymerizable hydrogen abstraction cross-linking compounds include mono-ethylenically-unsaturated aromatic ketone monomers free of orthoaromatic hydroxyl groups.

Examples of suitable free-radically (co)polymerizable cross-linking agents include but are not limited to those selected from the group consisting of 4-acryloxybenzophenone (ABP), para-acryloxyethoxybenzophenone, and para-N-(methacryloxyethyl)-carbamoylethoxy-benzophenone. (Co)polymerizable chemical cross-linking agents are typically included in the amount of about 0% to about 2%, and preferred in the amount of about 0.025% to about 0.5%, based on the total weight of monomer(s). Other useful (co)polymerizable cross-linking agents are described in U.S. Pat. No. 4,737,559.

Optional Photoinitiator(s)

In any of the processes of the present disclosure, the cross-linkable layer may further comprise a photoinitator added to the reaction mixture before, during, or after any one or more of step (a), (b), and/or (c). Preferably, the photoinitiator is also an ultraviolet radiation cross-linker. The optional photoinitiator may be added to the reaction mixture used in the processes of the present disclosure before, during, or after any one or more of step (a), (b), (c).

Although the optional photoinitiator(s) may be added before or during step (c), the photoinitiators used in the present disclosure are normally not intended to react with the ethylenicaly-unsaturated material during the (co)polymerization process initiated using a source of ionizing radiation as carried out in steps (a)-(c). In some exemplary processes of the present disclosure, one or more photoinitiators are added to the reaction mixture for use in initiating a subsequent photo-polymerization or photo-curing process, for example, during or after coating of the (co)polymer produced in the ionizing radiation-initiated (co)polymerization processes of the present disclosure onto a substrate. Such subsequent photo-curing processes are particularly well-suited for curing hot melt pressure sensitive adhesive layers. In such embodiments, it is presently-preferred that the optional photoinitiator is added to the (co)polymer after completion of step (c).

Useful classes of photoinitiators include substituted acetophenones such as benzyl dimethyl ketal and 1-hydroxycyclohexyl phenyl ketone, substituted alpha-ketols such as 2-methyl-2-hydroxypropiophenone, benzoin ethers such as benzoin methyl ether, benzoin isopropyl ether, substituted benzoin ethers such as anisoin methyl ether, and aromatic sulfonyl chlorides, and possibly photoactive oximes.

Particularly useful photoinitiators are commercially available under the trade designations DAROCURE TPO [CAS Name: 2,4,6-Trimethylbenzoyl-diphenyl-phosphineoxide], DAROCURE 1173 [CAS Name: 2-Hydroxy-2-methyl-1-phenyl-propan-1-one; CAS No.: 7473-98-5], IRGACURE 184 [CAS Name: 1-Hydroxy-cyclohexyl-phenyl-ketone; CAS No.: 947-19-3], IRGACURE 651 [CAS Name: 2,2-Dimethoxy-1,2-diphenylethan-1-one; CAS No. 24650-42-8], and IRGACURE 819 [CAS Name: Bis(2,4,6-trimethylbenzoyl)-phenylphosphineoxide], all manufactured by Ciba Specialty Chemicals, a subsidiary of BASF Corp. (Florham Park, N.J.); and ESACURE KK [CAS Name: benzene, (1-methylethenyl)-, homopolymer, Ar-(2-hydroxy-2-methyl-1-oxopropyl) derivatives; CAS No.: 163702-01-0] manufactured by Lamberti USA, Inc. (Hungerford, Tex.).

The photoinitiator may be used in an amount from about 0.001 to about 5.0 parts by weight per 100 parts of the total ethylenically-unsaturated material in the reaction mixture;

preferably from about 0.01 to about 5.0 parts by weight per 100 parts of the total ethylenically-unsaturated material in the reaction mixture; and more preferably in an amount from 0.1 to 0.5 parts by weight per 100 parts of the total ethylenically-unsaturated material in the reaction mixture.

In some exemplary embodiments, the cross-linked layer is formed by cross-linking, preferably radiation cross-linking, a cross-linkable thermoplastic (co)polymer such as those selected from the group consisting of polyolefins, polystyrenes, vinyl plastics, polyacrylates, polymethacrylates, poly(vinyl esters), polyamides, polycarbonates, polyketones, or it may be a copolymer comprising the polymerization product of at least one of the monomers from which the foregoing polymers may be derived and a co-polymerizable co-monomer. Suitable (co)polymers are described in U.S. Pat. No. 6,517,910.

Principal Film Precursors

Principal film precursors suitable for use in practicing certain exemplary methods of the present disclosure should generally be oriented films capable of thermally-induced self-forming.

Principal film precursors suitable for use in the practicing embodiments of the present disclosure should be capable of thermally-induced self-forming and typically are oriented, cast films comprising at least one crystalline or semi-crystalline (co)polymer. In some common embodiments, principle film precursors comprise oriented polyolefin polymers (e.g., polypropylene, polyethylene and the like, or combinations thereof). In addition, films capable of thermally-induced elastic recovery can be made from other materials (e.g., polyester, polystyrene, polyamide and the like)

Principal films of the disclosure typically comprise one or more (co)polymer, in particular oriented polyolefins and their blends. The term ‘polyolefin’ may constitute but is not limited to, (co)polymers of ethylene, propylene, butylene and the like as well as their random and/or block copolymers and blends. Optionally such films may constitute more than one layer, as for example, 2, 3, 5, 7 or higher numbers of layers. In this fashion different extents of thermally-induced elastic recovery may occur in different layers to produce films having novel and useful properties. Other films may be produced from (co)polymers such as polyesters, polystyrenes or other (co)polymers capable of forming oriented films. Non-oriented films may also be contemplated, providing their thickness permits hand tear-ability after exposure to the differential heating process described herein. In most cases non-oriented cast sheets exhibit a high tear force and produce irregular or non-straight tearing.

Suitable crystalline or semi-crystalline (co)polymers for use in the principal film precursor are known to those skilled in the art and many are commercially-available. Examples of suitable crystalline or semi-crystalline (co)polymers include block or random polyolefin copolymers; blends of polyolefin (co)polymers with one or more other (co)polymers having reduced or lower melting crystallite components and polyester (co)polymers.

Examples of suitable commercially-available materials polyolefin (co)polymers include ENGAGE™ 8401 and 8402, AFFINITY™ 820 and INFUSE™ 9507, (all from Dow Chemical Co., Midland, Mich.); VISTAMAXX™ 6202 (from ExxonMobil Chemical Co.); MF 502 matte polyolefin homopolymer (available from A. Schulman Co., Akron Ohio); various polypropylene (PP) homopolymers (available from Mayzo Co., Suwanee, Ga.); and PP 4792, a polypropylene homopolymer resin (available from Exxon-Mobil Co., Houston, Tex.).

Polyester (co)polymers can be particularly advantageous for use in the principal film precursor. Presently preferred polyester (co)polymers can be selected from poly(ethylene)terephthalate, poly(butylene)terephthalate, poly(trimethylene)terephthalate, poly(ethylene)naphthalate, poly(lactic acid) and combinations thereof.

Illustrative examples of films useful as principal film precursors in this disclosure include any polymer film capable of thermally induced elastic recovery (self-forming), including polyolefins, polyesters, glassy polymers such as polyvinyl chloride and polystyrene, acrylic polymers and the like Preferably the polymer films are oriented in at least one major direction (that is, LO or TDO meaning Length Orientation or Transverse Direction Orientation). Such oriented films are believed to provide a balance of toughness and ease of hand tearing once subjected to the differential thermal heating process.

Preferred films include sequentially or simultaneously biaxially oriented polyolefins comprising one or more component polyolefin resins and combinations of resins. Such film may in addition comprise more than one layer, preferably 2, 3, 5, 7 or more layers. Sequential or simultaneous biaxial orientation is preferably carried out using a tenter stretching process but may in addition be carried out by roller stretching, blown film stretching, or combinations thereof

The processes used to produce oriented (co)polymer films are well known and can be typically accomplished using blown film or tenter-stretched film processes. For reasons of economy and uniformity the tenter stretching process is most widely employed to produce films for adhesive tape backings, typically in the range from about 10 micrometers up to about 75 micrometers or more in thickness. Tenter stretching can be accomplished using either sequential or simultaneous stretching processes; the sequential stretching process is by far the most popular. In a typical sequential process, a film is produced by stretching first in the length direction, referred to as the LO; then in the transverse direction referred to as the TDO. In a simultaneous stretching process, the film is stretched concurrently in both the LO and TDO.

Sequential tenter stretching entails melting and casting the (co)polymer resin onto a chilled casting roller, then transporting the sheet to a first length orientation section. It is desirable to cast the film at a low temperature with maximum quenching, which retards the growth of large crystalline morphology and thereby produces the highest clarity and strength film.

Length orientation (LO) is usually accomplished by passing the cast sheet over a series of heated contact rollers that are driven at differential speed, thereby both heating and stretching the film in the length direction. Typical LO ratios are about 4 or 5:1 times. Following the LO step, the partially stretched film is then fixture along the edges using a series of tenter clips attached to the tenter stretching frame and then transported into the tenter oven. The tenter oven is usually heated to temperatures up to about the crystalline melting point temperature, allowing the film to soften sufficiently to allow transverse direction (TD) stretching to a ratio of about 8:1 to about 10:1.

Stretching a cast sheet at too low of a temperature requires very high forces and often results in the film tearing or breaking, especially in the tenter oven. Stretching a film at too high a temperature above the crystalline melting point results in the film exhibiting poor retained orientation as well as caliper defects caused by droop or sag in the tenter stretching process. See R. A. Phillips & T. Nguyen, J. Appl. Polym. Sci., v. 80, 2400-2415 (2001); and P. Dias et al., J. Appl. Polym. Sci., v. 107, 1730-1736 (2008). It is desirable to stretch the cast sheet at a temperature that allows for low force stretching but that also is below the melting point of the (co)polymer so that the film exhibits a high degree of molecular orientation, which is preferred for strength and dimensional stability in use.

In some embodiments, the oriented principal film precursor is a sequential tenter-stretched film exhibit an elastic recovery lower than about −2.0 N/m² as measured in the transverse film direction (TD) using a DMA. In some embodiments, principal film precursors used in accordance with the disclosure exhibit an initial tensile modulus in the transverse direction of less than about 2500 MPa as measured by Instron.

Illustrative examples of oriented principal film precursors useful in this disclosure include any (co)polymer film capable of thermally induced elastic recovery, including polyolefins, polyesters, glassy (co)polymers such as polyvinyl chloride and polystyrene, acrylic (co)polymers and the like Preferably the (co)polymer films are oriented in at least one major direction (that is, LO or TDO meaning Length Orientation or Transverse Direction Orientation). Such oriented films are believed to provide a balance of toughness and ease of hand tearing once subjected to the differential thermal heating process.

Preferred oriented principal film precursors include sequentially or simultaneously biaxially oriented polyolefins comprising one or more component polyolefin resins and combinations of resins. Such film may in addition comprise more than one layer, preferably 2, 3, 5, 7 or more layers. Sequential or simultaneous biaxial orientation is preferably carried out using a tenter stretching process but may in addition be carried out by roller stretching, blown film stretching, or combinations thereof.

In one embodiment, an oriented principal film precursor may comprise blends or layers including one (co)polymer resin having a melting point below the stretching or drawing temperature. Such lower melting components may be incorporated at any useful level, but typically comprise between about 5 to 95 weight % of the total.

In another embodiment a oriented principal film precursor may comprise blends of semi-crystalline and amorphous components in any combination. Component materials may include random or block copolymers or may include physical dispersions of semi-crystalline or amorphous phases of one or more materials.

In yet another embodiment an oriented principal film precursor may comprise a multilayer film in which at least one major face layer is a higher melting (co)polymer relative to base or core layers. In such films exposure to the differential thermal heating process may result in desirable structures on one or both major faces which may be useful for example in providing texture, adhesive release, liquid impermeability or the like.

In further embodiments an oriented principal film precursor may comprise a multilayer film in which at least one major face layer is a lower melting (co)polymer relative to base or core layers. Such films may be advantageous in providing softer surface layers yet still provide good liquid impermeability.

In an additional embodiment a film comprising multilayers including a surface layer comprising PP 9122 random propylene copolymer from Exxon-Mobil and a second base layer greater in thickness than the surface layer, comprising PP 5571 impact polypropylene was biaxially oriented in a sequential tenter stretching process to produce a film which exhibited very good hand tear-ability, good conformability, defined as the ability to form a tight radius when applied as an adhesive tape, good opacity and liquid impermeability.

Principal film precursors useful in the present disclosure may contain one or more components or layers in which the component or layer material is oriented at a temperature about equal to or greater than the component or layer melting point. It is thought that under such stretching conditions, the (co)polymeric component material is considered to experience ‘warm’ or ‘hot’ drawing, which imparts a low degree of orientation in the film, thereby limiting sufficient elastic recovery to form through-thickness perforations in the differential heating process.

It is believed that in such cases, the (co)polymer molecule orientation induced by the stretching process is either relaxed during the process as for example can occur with amorphous components, or that the oriented (co)polymer molecules, being semi-crystalline but having a lower melting temperature than the stretching process temperature, can re-crystallize in less oriented state upon cooling. (cf. J. Appl Polm Sci. referenced herein). Such films while not exhibiting perforations completely through the film thickness, still exhibit surprisingly good hand tear-ability.

It is believed that elastic recovery in oriented (co)polymers controls principal film precursor shrinkage and is related to the non-crystalline or amorphous ‘tie chains’ present in oriented semi-crystalline (co)polymers (See I. M. Ward et al., J. Appl. Polym. Sci., v. 41, 1659 (1990); and Structure and Properties of Oriented Polymers, ed. by I. M. Ward, Chapman and Hall, London (1997). On a molecular level, the elastic recovery arises from recoiling of the (co)polymer chains that were extended in the stretching process, resulting from melting of the crystalline component that served to hold the strained chains in place.

Elastic recovery is also believed related to the film making process conditions, especially the temperature of film casting (that is, the quenching or casting temperature) and the temperature of stretching. The casting temperature dictates the starting morphology of the semi-crystalline (co)polymer structure and is believed to influence the volume of tie chain material present during subsequent stretching. At low casting temperatures, crystallization is very rapid and produces many smaller crystallites and a larger volume of tie chains. At higher casting temperatures near to the melting point of the (co)polymer, crystallization is less rapid and produces fewer larger crystallites with a smaller volume of tie chains. (See Capt, L., et al. “Morphology Development during Biaxial Stretching of Polypropylene Films.” 17^{th} Polymer Processing Society Annual Meeting (2001).)

So-called taut tie chains present in stretched semi-crystalline (co)polymers are believed to be responsible for elastic recovery of the stretched oriented principal film precursors when exposed to heat (See B. Alcock et al. “The effect of processing conditions on the mechanical properties and thermal stability of highly oriented PP tapes,” Europ. Polym. J., 45 (2009): 2878-2894.).

In one embodiment a polymer film may comprise blends or layers including one polymer resin having a melting point below the stretching or drawing temperature. Such lower melting components may be incorporated at any useful level, but typically comprise between about 5 to 95 weight % of the total.

In another embodiment a polymer film may comprise blends of semi-crystalline and amorphous components in any combination. Component materials may include random or block copolymers, or may include physical dispersions of semi-crystalline or amorphous phases of one or more materials.

In an additional embodiment a polymer film may comprise a multilayer film in which at least one major face layer is a higher melting polymer relative to base or core layers. In such films exposure to the differential thermal heating process may result in desirable structures on one or both major faces which may be useful for example in providing texture, adhesive release, liquid impermeability or the like.

In a further embodiment a polymer film may comprise a multilayer film in which at least one major face layer is a lower melting polymer relative to base or core layers. Such films may be advantageous in providing softer surface layers yet still provide good hand tear-ability and liquid impermeability.

Similarly it is believed that blend materials and/or geometrical arrangements can result in producing a stretched film that is hand-tearable yet incapable of sufficient elastic recovery to lead to formation of an open perforation or hole. Examples of suitable materials include block or random polypropylene copolymers with reduced crystalline content; blends of polypropylene with one or more materials having reduced or lower melting crystallite components such that the blend when stretched exhibits insufficient elastic recovery; or two or more layers of film which exhibit insufficient elastic recovery in the stretched state so that one or more layers does not form open perforation or holes. Examples of suitable materials include ENGAGE™ 8401 and 8402, AFFINITY™ 820 and INFUSE™ 9507, (all from Dow Chemical Co., Midland, Mich.); and VISTAMAXX™ 6202 (from ExxonMobil Chemical Co.).

In another example, a biaxially oriented film made using a polypropylene impact copolymer containing about 15% of an impact modifier comprising ethylene-propylene rubber (EPR) dispersed in an isotactic polypropylene (available as grade 5571 from Total Petrochemicals USA, Houston, Tex.)) is found to produce no open perforation holes when exposed to the differential heating process of this disclosure, yet still exhibits thickened rims and most surprisingly, is still readily hand-tearable.

The configuration of sheets of the disclosure (e.g., an array of modification zones with relatively thickened rim portions and the like) can provide many useful advantages.

Heat-Treated Principal Films

In another embodiment, the disclosure provides a heat-treated oriented principal film including one or more (co)polymers and capable of thermally-induced self-forming and exhibiting a relaxation temperature (Tᵣ), the oriented heat-treated principal film having first and second major faces, a land portion on the second major face, one or more modification zones on the second major face and a cross-linked carrier layer in contact with the first major face. Each modification zone comprising a central closed portion and a rim portion surrounding the central closed portion and being surrounded by the land portion. The average thickness of each rim portion is greater than the average thickness of the land portion surrounding the central closed portion. The average thickness of each central closed portion is less than the average thickness of the land portion surrounding the central portion,

FIG. 3 shows a portion of an illustrative heat-treated principal film 110 of the present disclosure made from a suitable principal film precursor 100 (i.e., a cast film capable of thermally-induced elastic recovery) having: (1) first major face 14 and opposite second major face 16 (see FIG. 2); (2) a land portion 18′; and (3) one or more modification zones 20 each comprising a central portion 22 (which may be an opening or void region 12) and a rim portion 24 surrounding the central portion, the modification zone 20 being surrounded by land portion 18′ formed from major face 14.

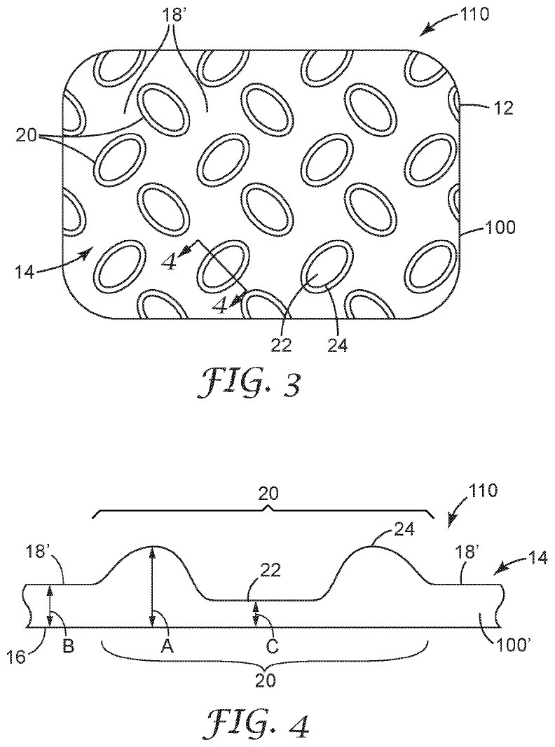

FIG. 4 shows a cross section of a modification zone 20 of an exemplary embodiment of a heat-treated principal film 110 comprising a heat-treated principal film precursor 100′ having first and second major faces, 18′ and 16, respectively. In accordance with the disclosure, land portion 18′ formed from major face 14 surrounds each modification zone 20, which are made up of rim portion 24 surrounding central portion 22. Central portion 22 generally has a non-zero thickness. The average thickness of rim portion 24 (dimension B) is greater than the average thickness of land portion 18′ (dimension A) which in turn is greater than the average thickness of central portion 22 (dimension C). Although the profile of thickness of central portion 22 may be curved (i.e., one or both of major faces 14 and 16 may be contoured throughout central portion 22 rather than being flat as shown), dimension C is preferably greater than zero throughout the central portion 22. The modification zone of films of this embodiment of the disclosure is impermeable rather than having through channels such as are found in previously known films formed via flame impingement.

It will be understood that FIGS. 3 and 4 are idealized; for instance, the second major face of the film may not be flat. Depending in part upon the nature of the principal film precursor and manner of carrying out differential heating, the modification zone may comprise some thickening and protrusion of the film on its second major face.

Optional Additives

The heat-treated principal films and/or principal film precursors of the present disclosure may optionally include one or more additives and other components as is known in the art. For example, the backing member or component members thereof may contain fillers, pigments and other colorants, anti-blocking agents, lubricants, plasticizers, processing aids, antistatic agents, nucleating agents (e.g., beta nucleating agents), antioxidants and heat stabilizing agents, ultraviolet-light stabilizing agents and other property modifiers (e.g., agents to improve compatibility, increase or decrease bonding properties and the like with desired adhesives and other materials). Fillers and other additives are preferably added in an amount selected so as not to adversely affect the properties attained by the preferred embodiments described herein.

Illustrative examples of organic fillers include organic dyes and resins, as well as organic fibers such as nylon and polyimide fibers and inclusions of other, optionally cross-linked, (co)polymers such as polyethylene, polyesters, polycarbonates, polystyrenes, polyamides, halogenated (co)polymers, poly (meth)acrylates, cyclo-olefin (co)polymers and the like. Illustrative examples of inorganic fillers include pigments, fumed silica and other forms of silicon dioxide, silicates such as aluminum silicate or magnesium silicate, kaolin, talc, sodium aluminum silicate, potassium aluminum silicate, calcium carbonate, magnesium carbonate, diatomaceous earth, gypsum, aluminum sulfate, barium sulfate, calcium phosphate, aluminum oxide, titanium dioxide, magnesium oxide, iron oxides, carbon fibers, carbon black, graphite, glass beads, glass bubbles, mineral fibers, clay particles, metal particles and the like.

In some applications it may be advantageous for voids to form around the filler particles during an orientation process or use entrained blowing agents to form voids. Organic and inorganic fillers may also be used effectively as anti-blocking agents. Alternatively, or in addition, lubricants such as polydimethyl siloxane oils, metal soaps, waxes, higher aliphatic esters and higher aliphatic acid amides (such as erucamide, oleamide, stearamide and behenamide) may be employed.

The heat-treated principal films and/or principal film precursors of the present disclosure may contain antistatic agents, including aliphatic tertiary amines, glycerol monostearates, alkali metal alkanesulfonates, ethoxylated or propoxylated polydiorganosiloxanes, polyethylene glycol esters, polyethylene glycol ethers, fatty acid esters, ethanol amides, mono- and diglycerides and ethoxylated fatty amines. Organic or inorganic nucleating agents may also be incorporated, such as dibenzylsorbitol or its derivatives, quinacridone and its derivatives, metal salts of benzoic acid such as sodium benzoate, sodium bis(4-tert-butyl-phenyl)phosphate, silica, talc and bentonite. Antioxidants and heat stabilizers can further be incorporated, including phenolic types (such as pentaerythrityl tetrakis [3-(3,5-di-tert-butyl-4-hydroxyphenyl)propionate] and 1,3,5-trimethyl-2,4,6-tris(3,5-di-tert-butyl-4-hydroxybenzyl)benzene) and alkali and alkaline earth metal stearates and carbonates. Other additives such as flame retardants, ultraviolet-light stabilizers, compatibilizers, antimicrobial agents (e.g., zinc oxide), electrical conductors and thermal conductors (e.g., aluminum oxide, boron nitride, aluminum nitride and nickel particles) may also be blended into the (co)polymers used to form the tape backing member.

Additives, fillers, pigments, dyes, UV stabilizers and nucleating agents may be useful components of the (co)polymeric heat-treated principal film and/or oriented principal film precursor in the practice of this disclosure. Relative proportions and methods of inclusion are well known to those skilled in the art.

Optional Adhesives

In some exemplary embodiments, the heat-treated principal film may be useful as a backing member in an adhesive article. In such embodiments, at least one major face of the heat-treated principal film is preferably coated with an adhesive material, more preferably a pressure sensitive adhesive.

The adhesive may be any suitable adhesive as is known in the art. Preferred adhesives are normally tacky, pressure sensitive adhesives. Selection of adhesive will be dependent in large part upon the intended use of the resultant tape. Illustrative examples of suitable adhesives include those based on (meth)acrylate (co)polymers, rubber resins such as natural rubber, butyl rubber, styrene copolymers and the like, silicones and combinations thereof The adhesive may be applied by solution, water-based or hot-melt coating methods. The adhesive can include hot melt-coated formulations, transfer-coated formulations, solvent-coated formulations and latex formulations, as well as laminating, thermally-activated and water-activated adhesives and are not limited except so as to provide a desirable balance of tape roller unwind and adhesion properties.

Illustrative examples of tackified rubber hot melt adhesives that are suitable for use in tapes of the disclosure are disclosed in U.S. Pat. Nos. 4,125,665, 4,152,231 and 4,756,337. Illustrative examples of acrylic hot melt adhesives that are suitable for use in tapes of the disclosure are disclosed in U.S. Pat. Nos. 4,656,213 and 5,804,610.

In certain embodiments, a low adhesion backsize (“LAB”) comprising a low surface energy release material such as a polysiloxane (co)polymer, a highly-fluorinate (co)polymer such as a perfluoro-(co)polymer, or a side chain crystallizable (meth)acrylate (co)polymer, may be advantageously applied to an opposing major face of the heat-treated principal film opposite the adhesive material.

In other exemplary embodiments, a release liner comprising a low adhesion backsize (“LAB”) including a low surface energy release material such as a polysiloxane (co)polymer, a highly-fluorinate (co)polymer such as a perfluoro-(co)polymer, or a side chain crystallizable (meth)acrylate (co)polymer, may be positioned adjacent to and adjoining an opposing major face of the heat-treated principal film opposite the adhesive material. The use of a release liner is particularly advantageous when it is desirable to wind the heat-treated principal film into roller form, for example, for use as an adhesive tape.

Those skilled in the art will be able to select suitable adhesives and release materials for use in the disclosure, dependent in large part upon the desired application.

Those skilled in the art will be able to select rotary rod or other suitable coating techniques for applying adhesive and/or a release material to a major face of the heat-treated principal film for use in articles of the present disclosure. Selection of the coating method will be dependent in part upon the flow characteristics of the adhesive, desired penetration of adhesive into perforations and the like Those skilled in the art will be able to readily select suitable methods for applying or coating adhesive on the sheet. Illustrative examples include rotary rod die coating, knife coating, drop die coating and the like Illustrative examples of rotary rod coating methods that may be used to make tapes of the disclosure are disclosed in U.S. Pat. Nos. 4,167,914, 4,465,015 and 4,757,782.

To enhance adhesion between the backing member and the adhesive, adhesion promoting treatment(s) may be applied to the second major face of the backing member, e.g., flame treatment under fuel-lean conditions, exposure to corona, chemical primers and the like

Pressure sensitive adhesives are well known to possess aggressive and permanent tack, adherence with no more than finger pressure and sufficient ability to hold onto an adherend.

Additionally, the adhesives can contain additives such as tackifiers, plasticizers, fillers, antioxidants, stabilizers, pigments, diffusing materials, curatives, fibers, filaments and solvents.

In some embodiments, the adhesive optionally can be cured by any suitable method to modify the properties thereof including rendering it less likely to flow. In particular the cross-linking level can be chosen so as to provide a balance of good tape roller unwind and finished adhesive properties. Typical cross-linking can be provided by well-known methods such as radiation-induced cross-linking (for example, UV or e-beam); thermally induced cross-linking, chemically reactive cross-linking or combinations thereof.

The adhesive may be applied in any desired amount and typically is applied to provide a conventional dry coating weight between about 5 to about 100 g/m². Thicker adhesive coatings tend to increase probability of causing undesirable increases in unwind force. Too thin coatings are not functional or tend to wet substrate surfaces poorly.

A general description of useful pressure sensitive adhesives may be found in the Encyclopedia of Polymer Science and Engineering, Vol. 13, Wiley-Interscience Publishers (New York, 1988). Additional description of useful pressure sensitive adhesives may be found in the Encyclopedia of Polymer Science and Technology, Vol. 1, Interscience Publishers (New York, 1964).

Following application of adhesive to the backing member, tape of the disclosure may be converted to desired configurations using known approaches, e.g., slitting, rolling and the like Sheets of tape of the disclosure may be wound into roller form (e.g., one or more sheets of the tape wound upon itself about an optional core) or stacked in sheet form. In accordance with the disclosure, surprising advantages provided by such tape assemblies include easy unwind as the interface between the adhesive layer of overlying plies and first major face with raised rims of the heat-treated principal film of underlying plies separate easily, as well as good hand tear, conformability and other tape properties.

### Adhesive Articles

The heat-treated heat-treated principal films of the present disclosure can be used to manufacture films, tapes or sheets, which may be adhesive-backed or not, for many applications including packaging tapes, paint masking tapes, general utility or “duct” tapes, medical tapes, masking films, liners, wraps, as well as laminates with one or more additional layers including nonwovens, foams and the like

Adhesive Tapes

The heat-treated heat-treated principal films may be used advantageously as a backing in an adhesive tape. In some exemplary embodiments, the adhesive tape comprises an adhesive layer on one or both of the first and the second major faces of the heat-treated principal film. In certain such embodiments, the adhesive layer comprises a pressure sensitive adhesive. In some advantageous embodiments, the adhesive layer is discontinuous. In other advantageous embodiments, the adhesive layer is substantially continuous. Generally, the adhesive layer has an average coating weight of from about 5 to about 100 g/m²; 10 to 90 g/m², 15 to 75 g/m², or even 20 to 50 g/m².

In certain exemplary embodiments, the adhesive layer is positioned on only the cross-linked carrier layer or the second major face of the heat-treated principal film. In certain such embodiments, a release coating may be advantageously applied on at least a portion of the heat-treated principal film opposite the adhesive layer. In some such embodiments, the release coating is applied on substantially the entire major face of the heat-treated principal film opposite the adhesive layer.

By eliminating the need for such coatings or liners, the present disclosure enables significant simplification of tape manufacture and use because no coating steps, drying ovens, solvent recovery systems, or radiation curing processes, as are typically involved with use of release coatings, are necessary. Elimination of solvents eliminates volatile organic compounds and also eliminates the energy to run ovens such that the overall tape manufacturing process is more efficient. The absence of oven drying causes less thermal damage to oriented film substrates, simplifies web handling operations and enables use of a much smaller space for manufacturing operation.

The rims of melted polymer on the first major face of the heat-treated principal film enable the smooth and easy unwind of tapes made therefrom in accordance with the disclosure. It is thought that the maximum height of the rims is a critical parameter enabling adhesive release and subsequent unwind because the highest points on the rim are the locations that hold the pressure sensitive adhesive farthest from the primary surface of the perforated film (i.e., the portion of the first face or side between perforations and their rims). Adhesion between the highest points of the melted rim of modification zones formed with a fuel-rich flame and the adhesive will be limited because the small area of contact between the rim and the adhesive and the low extent of oxidation of the rim.

The configuration and arrangement of the modification zones provide a heat-treated principal film that can be readily torn in straight or substantially straight lines, yet has a sufficient tensile strength to be used as a backing member in adhesive tapes. Tear initiation and propagation parameters of tapes can be controlled as desired by controlling the arrangement and geometry of the modification zones.

The heat-treated principal film can typically be torn under the force applied by human hands (is hand-tearable) in at least one direction and can be formed such that it is hand-tearable in two perpendicular directions. The heat-treated principal films of the disclosure can have relatively low tear initiation energy and relatively high tear propagation energy as compared to similar polymeric films that are not modified to possess modification zones in accordance with the disclosure. In addition, the modification zones of heat-treated principal films of the disclosure allow tearing of the films in substantially straight lines compared to similar polymeric films that have not been modified in accordance with the disclosure. The modification zones allow such improved tear properties without excessively weakening the tensile strength of the film.

Through control of film properties (e.g., tenter ratio/magnitude, film thickness and the like) and differential heating process conditions and equipment (e.g., film speed and thickness, arrangement and shape of heating zones and the like), the position, spacing and shape of modification zones may be controlled as desired (e.g., to optimize tear initiation and propagation forces, tear directionality, conformability and the like). For instance, the modification zones may be substantially circular, oval, diamond-shaped, triangular, or of some other geometry and may be arranged in an ordered homogeneous array or in an irregular manner (e.g., where spacing or relative position or both are varied).

In some embodiments in which easier tear of an adhesive tape comprising a heat-treated principal film of the disclosure as the backing is desired, the modification zones in the polymeric film are typically preferably non-circular and have a length at least 1.25 times their width and typically at least 2 times their width. Although different individual modification zones across the heat-treated principal film may exhibit variation, with their respective central portions and surrounding rim portions varying somewhat in size, they typically each have a major axis and a minor axis. The major axis is a line along the length of the modification zone and the minor axis is a line along the width of the modification zone (e.g., to create a herringbone pattern). In one implementation, a line projected along the major axis of each modification zone passes through an adjacent second modification zone. In specific implementations a line projected along the major axis of each modification zone passes through an adjacent modification zone along or parallel to the minor axis of the adjacent modification zone.

In accordance with one embodiment of the disclosure, the modification zones are arranged in a fashion such that they promote easy tearing of the film in the down-web or machine direction (MD) and in the cross-web or transverse direction (TD). The modification zones sufficiently preserve the tensile strength of the film that it may be sufficiently robust to serve as a tape backing while imparting desirable straight line tearing characteristic to the film such that it can be used conveniently as a tape backing. The disclosure enables formation of hand-tearable sheets and tapes using polymeric films as backings that would otherwise exhibit undesirable tear and tensile properties such as slivering when peeled from a roller or surface to which they have been applied (e.g., such as with masking tape), unduly high tear initiation force, unduly high tear propagation force, tendency to result in jagged or non-straight tear lines and the like.

Adhesive tapes made using films of the disclosure can provide superior tear properties such as controlled tear propagation to avoid slivering, splitting and unpredictable failure; uniform texture for eased of handling and application and the ability to visually indicate proper adherence by serving as a visual indicator of adhesive wet-out. The latter performance parameter is particularly valuable for embodiments where films of the disclosure are used as backings for masking tapes.

In many embodiments, the central portions and complementary surrounding rim portions are typically circles, elongate ovals, rectangles, or other shapes arranged in a fashion such that the major axis of each modification zone intersects adjacent modification zones or passes near adjacent modification zones to provide optimum tear properties.

A feature of tapes of the disclosure is the modification zones in the backing each have a raised ridge or rim formed during flame impingement. This raised ridge consists of polymer material from the interior of the modification zone that has elastically recovered from the orientation imposed on the principal film precursor. Previously, this rim has been observed to provide enhanced tear properties of the perforated film and to also impart slight textures that cause the film to more closely resemble a conformable material. As discussed above, such raised ridges or rims have been surprisingly found to eliminate the need for use of a release coating or liner in an adhesive tape construction.

As discussed in U.S. Pat. No. 7,037,100 with reference to FIG. 4 therein,
“The perforation pattern formed in polymeric film 14 has a strong influence on the tear and tensile properties of the cloth-like films and tape backings of the disclosure. In reference now to FIG. 4, a portion of an enlarged layout of a typical perforation pattern 28 is shown, with the machine direction oriented up and down and the transverse direction oriented left to right. Depicted perforation pattern 28 comprises a series of rows of perforations, identified as a first row having perforations 1a, 1b and 1c; a second row having perforations 2a, 2b and 2c; a third row having perforations 3a, 3b and 3c; a fourth row having perforations 4a, 4b and 4c; and a fifth row having perorations 5a, 5b and 5c. Typically the perforations form a pattern extending along most or all of the surface of a film and thus the pattern shown in FIG. 4 is just a portion of one such pattern.”

U.S. Pat. No. 6,635,334 (Jackson et al.) and U.S. Pat. No. 7,138,169 (Shiota et al.) disclose a number of patterns that might be used in for modification zones in a heat-treated principal film of the present disclosure to attain desired resultant tear, crease, folding and other physical properties of the resultant tape. In accordance with the present disclosure, such patterns may be used to form closed modification zones (i.e., central portions of the modification zones do not penetrate completely through the film in the manner of the perforations disclosed in the prior art).

Without wishing to be bound by any theory, it is believed that the density of the modification zone pattern contributes to both the conformability and fold-ability of the films and tapes of this disclosure and the tear and tensile properties and that lowering the density or changing its distribution in such a way as to provide channels, along either the machine direction (MD) or the cross-web or transverse direction (TD) or both, in which a propagating tear might encounter no modification zones, results in decreased conformability and less desirable tear and tensile properties along the direction of such a modification free channel, compared to the most preferred pattern. Tapes of this disclosure conform to substrates such as boxes, containers, skin, automotive parts and panels and other materials thereby enabling the intimate contact of the pressure sensitive adhesive with the part or substrate and thus increasing the adhesion between the tape and the substrate. In addition, adhesive tapes of present disclosure can be folded so as to produce a soft paint edge when used in a typical paint spraying operation, as is well known for comparable paper-backed masking tapes.

Also, it is believed that the raised rim portion around each central portion serves to blunt propagation of the tear, resulting in better control of the tear by hand and increase in tear propagation force (relative to that of unperforated film). The tear initiation force, however, is reduced, relative to that of principal film precursor, especially for the most preferred pattern, because the modification zone density guarantees that the edge of any film or tape so constructed will have modification zones either at or extremely near the edge. Surprisingly, it has been found that tapes made as described herein can exhibit very sharp and uniform paint lines when used in masking applications, even with the as-described modification zones and differential thickness. It is believed that such films and the resultant tapes have superior conformability in the thickness or z-axis dimension, thereby allowing improved contact to the substrate to which they are adhered. Therefore, for the purposes of tear initiation, the inventive films and tapes behave similarly to notched films but without the occurrence of significant slivering, which is a problem for paper-backed masking tapes especially when utilized in a wet environment.

A surprising and advantageous aspect of the disclosure is that the modification zones are impermeable, that is they do not penetrate completely through the heat-treated principal film.

It is known (e.g., from U.S. Pat. No. 7,037,100 and the like) that oriented polymeric films can be exposed to a high heat flux source such as a flame while wrapped on a cooled tooled backing roller, causing differential heating of the two major faces. It is thought that the exposure of the film sections directly spanning a tooled indentation in the cooled backing roller causes a very rapid heating of that film section which causes a sudden, uncontrolled release or relaxation of the film orientation and results in a perforation being formed with associated ‘rim’ material at the margins of the modification zone, comprising the mass of relaxed polymer molecules caused by this shrinkage. This process is termed thermally induced elastic recovery.

This can be visualized in FIG. 2, in which “A” =the thickness of the rim, “B” =the thickness of the land portion and “C” =the thickness of the central portion which is a perforation (i.e., it reaches zero). In the prior art heat-treated films, the differential heating process causes thermal modification to result in the rim section “A” being at least as thick as the land portion “B” and the central portion “C” has zero thickness. The utility of such prior art films is thus limited by the presence of the perforations, which are permeable to fluids and which do not allow their use directly as paint masking tape backings or masking sheets and also prevents their use as substrates in coating processes involving liquid coating materials such as solvent or water-based coatings.

The present disclosure relates to the surprising discovery that, by using principal film precursors such as a described herein, modification zones with closed central portions can be formed rather than modification zones with open perforations as was previously known.

Thus, as shown in FIG. 4, in films of the present disclosure, the modification zone comprises a central portion C, surrounded by a rim portion A surrounded by land portion B. Unlike the prior art films, central portion C has a thickness greater than zero. In embodiments of this disclosure, application of differential heating induces the novel result that the thermal modification zone “C” is greater than zero, yet still provides for ready hand tearing of the film. In this embodiment, the thickness of the rim portion of the modification zone “A” approaches that of the surrounding land portion “B” and is thicker in other areas. The thickness of the central portion “C” is always less than both “A” and “B” and, in a departure from the art, may be greater than zero.

Such films can be used as paint masking adhesive tape backings or sheeting and can be used in liquid coating processes. Films of the disclosure in addition exhibit good tear properties, good strength, good conformability and stretch, excellent water resistance as well as low unwind when used as a roller of adhesive coated tape. In addition, the structure imparted by the thermal modification process results in an adhesive tape or sheet which is easier to handle due to the relative increase in thickness or loft of the film as well as the texture thus imparted.

Not to be bound by theory, it is currently thought that the inventive films have a lower degree of overall molecular orientation, which results in the gross film having a reduced amount of elastic recovery or shrinkage in the direction of maximum stretching. For typically sequentially oriented polymer films, this direction is the TD direction. For simultaneously oriented films this direction would be that of highest stretching extent or in balanced films, along both major axes. It is thought that the thermally induced elastic recovery of the orientation produced by the stretching process is the driving force behind formation of the open perforations and surrounded by thickened rims as in the prior art example; in the present case the inventive films have less than some critical level of elastic recovery potential available so as to form thinned but not open central portions. The ability to form films with such impermeable modification zones is believed to be due to the nature of the oriented film used as the principal film precursor.

For many embodiments in which easy hand tearing is desired, it is sometimes preferred that the resultant heat-treated principal film exhibit an un-notched tear strengths of about 100 gram-force (g_{f})/mil-thickness or less, more preferably about 70 g_{f}/mil-thickness or less and most preferably about 55 g_{f}/mil-thickness (e.g., in the transverse direction of a tape). If the film's tear force is too high then the film may be unduly difficult to tear by hand, though in some applications of films of the disclosure this may be acceptable.

If desired, a tape may be made wherein the heat-treated principal film has first segment having a first array of a plurality of modification zones and a second segment having a second array of a plurality of modification zones wherein the first array differs from the second array in one or more characteristics. This can be achieved by using a backing roller having corresponding arrays of depressions to form the multiple segments simultaneously or forming the respective segments of modification zones sequentially.

As desired, respective arrays of modification zones may be formed that include differences in one or more of the characteristics selected from the group consisting of: (1) average distance between adjacent modification zones, (2) shape of modification zones, (3) dimension of modification zones and (4) average thickness of rim portions.

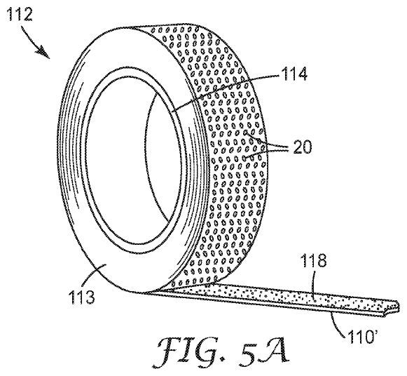

FIG. 5A shows an illustrative roll 112 of adhesive tape 113 including the heat-treated principal film 110 of the present disclosure. The roll 112 comprises adhesive tape 113 wound upon itself into roll form on an optional core 114. Adhesive tape 113 comprises a cast heat-treated principal film 110 comprising a plurality of modification zones 20 and adhesive layer 118. Each modification zone 20 comprises a closed central portion and a rim portion surrounding the closed central portion and being surrounded by the land portion. The adhesive layer 118 may be applied to either one or both major surfaces of the adhesive tape 112.

In some embodiments, such as a rolled form of a heat-treated principal film of the disclosure (e.g., a rolled bare sheet or adhesive-backed roller), the heat-treated principal film consists of a single homogenous segment (i.e., a sheet comprising a uniform array of modification zones). In other embodiments, the heat-treated principal film may comprise two or more segments where the segments differ in nature or even presence of modification zones.

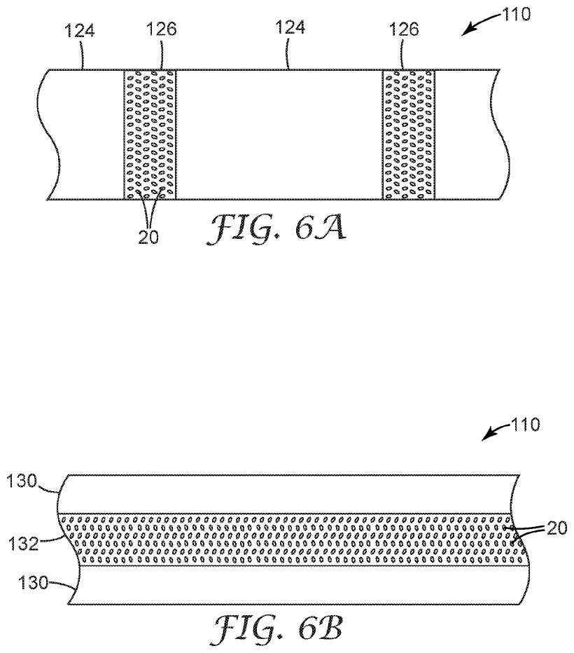

FIG. 6A shows an illustrative embodiment of a heat-treated principal film 110 of the disclosure wherein heat-treated principal film 110 is an elongate tape comprising a plurality of segments 124 which do not have modification zones interspersed with segments 126 having modification zones 20 in accordance with the disclosure. In a tape application, such configuration may be used to render the film more easily conformed or separable at discrete lengths, corresponding to segments 126. The segments may be of desired relative size and spacing.

FIG. 6B shows another illustrative embodiment wherein heat-treated principal film 110 is an elongate tape comprising a central segment 132 having modification zones 20 with adjacent segments 130 which do not have modification zones. In a tape configuration, such configuration may be used to render the film more easily conformable in an elongate middle portion (e.g., to bend around a wall corner). As will be understood, heat-treated principal films of the disclosure may be made with other desired configurations of one or more first segments having an array of modification zones 20 and one or more other segments having no modification zones or arrays of modification zones that differ from that of the first segment(s). In this manner, heat-treated principal films having varying properties such as tear strength, conformability and the like at different locations and in different configurations may be realized in accordance with the disclosure.

In further exemplary embodiments, the heat-treated principal film and overlaying oriented heat-treated principal film make up a backing member having front and rear major faces and an adhesive layer, preferably comprising a pressure sensitive adhesive, is applied to at least a portion of the major face of the oriented heat-treated principal film forming the backing member. In certain such embodiments, the oriented heat-treated principal film advantageously comprises a (co)polymer selected from the group consisting of polyester, polystyrene, biaxially-oriented polypropylene and a combination thereof In some such embodiments, the polyester (co)polymer is advantageously selected from the group consisting of poly(ethylene)terephthalate, poly(butylene)terephthalate, poly(trimethylene)terephthalate, poly(ethylene)naphthalate, poly(lactic acid) and combinations thereof. In additional such embodiments, the cast (co)polymeric component of the heat-treated principal film comprises a non-oriented polyolefin (co)polymer. In certain presently-preferred embodiments, the polyolefin (co)polymer is an ethylene acrylic acid copolymer.

### Hand-Tearability and Other Advantages

The use of (co)polymeric heat-treated principal films as backings for adhesive tape applications as enabled by the present disclosure can yield tapes offering several distinct advantages. One of the advantages of embodiments of the present disclosure is that the tear strength of principal film precursors may be reduced to more useful magnitude. Typically, a heat-treated principal film of the disclosure has one or more segments have a tear strength of about 100 g_{f}/mil-thickness or less, in some embodiments about 70 g_{f}/mil-thickness or less and in some embodiments, about 55 g_{f}/mil-thickness or less.

Adhesive tapes are widely used for bonding, joining, or masking applications. An essential aspect of such adhesive tapes is the presence of a tape backing, to which self-adhesive and release coatings are affixed. It is essential to the use of an adhesive tape that the adhesive tape backings be capable of dispensing using a tool or tearing by hand to permit separation of useful lengths of tape from the roller. Especially in the area of masking tape applications, it is essential that a desired portion tape be readily torn by hand directly from the adhesive tape roller without the use of any tools or tape dispensing equipment. This enables the flexible, fastest use of the masking tape. As used herein, hand tear-ability refers to the ability of the tape to be torn by hand, or, hand tear-ability, as the ability of an average person to be able to tear a length or sheet of said backing readily with only reasonable and not undue effort. In some aspects, it is desirable to be able to apply a sharp force quickly to ‘snap’ the tape into a useful length.

Historically adhesive masking tapes have been constructed with paper backings to facilitate handling and application, especially tearing by hand. Because of the inherent fragility and porosity of paper tape backings, such backings must be modified by coating with one or more (co)polymeric materials (e.g., barrier coats, binders, saturants and the like) in order to confer desired strength, elasticity and ability to withstand exposure to and hold out liquid coatings. Such coatings are usually applied in one or more coating operations, followed by curing or drying to fix the coating in place. This necessitates the use of a multi-step coating process line to enable the paper treatment operations followed by the applications of release and adhesive coatings to produce the desired product. Alternatively, precoating barrier coats, saturants and binders to the paper may occur in a separate operation prior to adhesive coating.

Even with the addition of barrier coats, binders and saturants, there are distinct disadvantages to use of paper backings for adhesive masking tape construction. Paper backings are inherently unstable when exposed to water or ultraviolet light and tend to shred when used in applications requiring “wet sanding,” or sanding with water, typically utilized in such industries as automotive painting. Paper backings do not tear in a straight tearing fashion, tending instead to tear at varying angles, known as slivering, and to leave shredded edges where torn. Many modern paper based adhesive masking tapes are produced using calendared or specially smoothed paper backings, which enable more uniform paint lines once removed. Still, since paper is composed of bonded paper fibers the paint lines thus formed are typically not as sharp as would be the case for a (co)polymeric tape backing; such paper backings are usually thicker than (co)polymeric film backings.

Moreover, paper backed tapes are typically too stiff and lack sufficient elongation to permit application in smooth curved manner (i.e., bending in the x-y dimension so as to form a curved paint line on a flat surface). Typically, paper-backed tapes have an elongation of less than about 25% and in some instances less than 15%, making them unsuitable for masking many desired configurations. Finally, the paper-based masking tapes can have a relatively high production cost due to the requirement to apply the barrier, binder and saturant coatings. It should be mentioned that each such step also leads to waste either in terms of solvent removal and mitigation or in terms of thermal requirements to dry said coatings.

(Co)polymeric films, especially polyolefin based (co)polymeric films, are typically moisture and water insensitive, have typically low profiles, high strength, good conformability and low cost. However, except for several particular types of (co)polymeric backing, most (co)polymeric adhesive tapes are difficult or impossible to tear hand without the use of a tool or tape dispensing blade.

Thus, one of the advantages of adhesive tapes using the heat-treated heat-treated principal films of the present disclosure as a backing is that the tear strength of the adhesive tape may be reduced to a more useful magnitude. Preferably, the heat-treated principal films of the present disclosure are hand-tearable. By hand-tearable, we mean that the heat-treated principal film has one or more segments have a tear strength of about 100 g_{f}/mil-thickness or less, in some embodiments about 70 g_{f}/mil-thickness or less and in certain embodiments, about 55 g_{f}/mil-thickness or less.

Additionally, in some embodiments, it has been found that backing members comprised of heat-treated principal films as described herein (i.e., raised rims protruding from the first major face of the backing in modification zones) can enable release from the adhesive of overlying tape portions or sheets from underlying portions without use of a release coating on the first side of the backing or an intervening removable release liner. Such rims are of sufficient height to enable the finished tape to be unwound without excessive force, tearing of the backing, or cohesive failure of the adhesive.

The heat-treated principal films provided by the present disclosure may, in some embodiments, uniquely provide various desired combinations of attributes, including for example, in certain exemplary embodiments convenient hand tear-ability, inherent moisture and water resistance, resistance to slivering, straight-line tear propagation, low profile, low cost, high conformability that is, the ability to be formed into a radius with a continuous flat outer or convex edge due to both the inherent flexibility of (co)polymeric films and the additional ‘give’ flame impinged films have due to the thinned central portions. Additionally, the heat-treated principal films provided by the present disclosure generally do not require use of barrier, binder or saturation coatings when used in adhesive tape applications.

The operation of various embodiments of the present disclosure will be further described with regard to the following detailed examples. These examples are offered to further illustrate the various specific and preferred embodiments and techniques. It should be understood, however, that many variations and modifications may be made while remaining within the scope of the present disclosure.

### EXAMPLES

These Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least and not as an attempt to limit the application of the doctrine of equivalents to the scope of the claims, each numerical parameter should at least be construed in light of the number of reported significant digits and by applying ordinary rounding techniques.

### Summary of Materials

Unless otherwise noted, all parts, percentages, ratios and the like in the Examples and the rest of the specification are by weight. Solvents and other reagents used may be obtained from Sigma-Aldrich Chemical Company (Milwaukee, Wis.) unless otherwise noted.

### Test Methods

Constrained Thermally Induced Elastic Recovery Test

The thermally induced elastic recovery stress of test specimens were measured using a TA Instrument model RSA G2 Dynamic Mechanical Analyzer (TA Instruments, New Castle, Del.) in tensile mode.

Test specimens were cut along the major axis of film direction for measurements; practically this means the transverse film direction (TD) at a dimension of 6.2 mm in the MD and 25 mm in the TD. Specimens were clamped with a fixed strain of 1% so that the testing strip was positioned flat and even. Specimens were first conditioned at 30° C. for 2 mins and then subjected to heating from 30° C. to 190° C. at the rate of 3° C./min. Under these conditions of fixed clamping, upon heating an axial retractive or elastic recovery force is generated with increasing temperature as the crystalline or other hard phase segments of the film soften and melt. In the tensile mode of the DMA, the axial force at a fixed strain reflects the recovering stress released during the heating. The plot of normalized stress over temperature shows the stress change during the elastic recovery caused by heating. The normalized stress is obtained by normalizing axial force by the area of the film cross section. Because the thermally induced stress is exerted on the specimen clamps in the direction of strain, the values reported are negative (that is, the test specimen exert a pull or tensile retractive force on the force transducers to which the clips are affixed).

Optical Microscopy Test Method

The optical microscopic images of the test samples were taken using Olympus optical microscope with a digital camera (Model no. BX51TRF). Test specimens were cut into approximate dimension of 25 mm in width and 75 mm in length. Specimens were mounted on a glass slide and placed under the objective of the microscope. The images were captured under 2.5× magnification.

Ink Penetration Test

For ink penetration test, the samples were cut into sheets of approximate dimensions 305 mm by 150 mm. Sample sheets were overlaid on a A4 size (210×297 mm) printing paper. A king size Sharpie permanent marker was used to apply the ink on the top side of sample sheet (side not facing the paper). Ink penetration was reported after analyzing whether the ink penetrated through the sample sheet to the paper.

High-Speed On-Line Optical Measurement System

A high-speed camera with a confocal lens and backlight was used to inspect the modification zones in the heat-treated principal films during processing on the web line. The inspection system was mounted downstream of the heat-treating process.

### Precursor (Co)polymer Films

The film used in Comparative Example C1 and Example 1 is a simultaneously biaxially oriented polypropylene (SBOPP—7282G) as described in International Patent Pub. No. WO2016/10551.

The film used in Comparative Example C2 and Example 2 is a commercially available biaxially oriented polypropylene (BOPP) film that does not allow for a closed flame perforation process window as described in International Patent Pub. No. WO2016/10551. The film has a length direction orientation ratio of 5/1 and a transverse-direction orientation ratio of 9/1.

The film used in this Comparative Example C3 and Example 3 is a poly(ethylene terephthalate) (PET) film from 3M Company (St. Paul, Minn.).

The film used in Comparative Examples C4 and C5 and Example 4 is a simultaneously biaxially oriented polypropylene (SBOPP) from 3M Company (Greenville, N.C.), as described in International Patent Pub. No. WO2016/10551.

### Flame Impingement Differential Heat-Treating Process

The flame impingement differential heat-treating apparatus shown in FIG. 1 was used to produce the Examples. The flame impingement differential heat-treating apparatus as generally shown in FIG. 3 of U.S. Pat. No. 7,037,100 was used to produce the Comparative Examples. The following operating conditions were used.

Compressed air was premixed with a natural gas fuel (having a stoichiometric ratio of 9.7:1 and a heat content of 37.7 kJ/L) in a venturi mixer from Flynn Burner Corporation (Mooresville, N.C.) to form a combustible mixture. The flows of air and natural gas were measured with thermal mass flow meters from Fox Thermal Instruments, Inc. (Marina, Calif.) and the flow rates of natural gas and air were controlled with servo-motor-driven needle valves from Flynn Burner Corporation (Mooresville, N.C.). All flow rates were adjusted to result in a flame equivalence ratio of 0.97 (air/fuel ratio of 10/1) and a normalized power of 725 to 1100 W/cm² of burner area (12,000 to 18,000 Btu/hr-in. of burner length). The combustible mixture passed through piping to a ribbon burner of the type described in U.S. Pat. No. 7,635,264, comprising a 30.5 cm long×1.9 cm wide, 8-port corrugated stainless steel ribbon mounted in a water-cooled aluminum housing from Flynn Burner Corporation (Mooresville, N.C.).

The burner was mounted adjacent to a 35.5 cm diameter, 46 cm face-width, chilled steel backing roller from American Roller Company (Union Grove, Wis.). The temperature of the backing roller was controlled by a 240 L/min recirculating flow of water at a temperature of 10° C. The face of the backing roller was plated with 0.5 mm of copper, the central 29 cm of the face of the roller was etched with the perforation pattern shown in FIG. 6 of U.S. Pat. No. 7,037,100 and then the entire face was coated with 0.01 mm of chrome by Custom Etch Rolls Inc. (New Castle, Pa.). Filtered, compressed air at a pressure of about 35 kPa/m² (5 psig) was blown onto the backing roller to controllably reduce the amount of water condensation on the central, patterned portion of the backing roller. The distance between the face of the burner housing and the face of the backing roller, which is the D distance in FIG. 4 of U.S. Pat. No. 7,037,100, was adjusted to 12 mm. The E distance in FIG. 4 of U.S. Pat. No. 7,037,100 was equal to 3 mm.

The heat-treated principal film precursors were guided by idler rollers to wrap around the chilled backing roller and over the patterned portion of the roller and passed through the flame impingement process at a speed of 6-30 m/min. The upstream and downstream tension of the film was maintained at approximately 2.2 N/lineal cm. To insure intimate contact between the polypropylene film and the chilled backing roller, a 10 cm diameter, 40 cm face-width inbound nip roller covered with 6 mm of Arcomax 8007™ elastomer from American Roller Company (Union Grove, Wis.), was located approximately 45 degrees relative to the burner on the inbound side of the chilled backing roller. Positioned between the nip roller and the burner was a water-cooled shield maintained at a temperature of 38° C. with recirculating water. The nip roller-to-backing roller contact pressure was maintained at approximately 50 N/lineal cm.

### Comparative Example C1 and Example 1

The principal film precursor is a simultaneously biaxially oriented polypropylene (SBOPP) as described in patent application WO2016-10551. An ¾ in.×¾ in square pattern of magenta color DICE Type G ink available from Prototype and Production Systems, Inc. (Plymouth, Minn.) was inkjet printed on the film using a Prototype & Production Systems Inc. DICElab single-pass printer with a Fujifilm Starfire SG1024/SA piezoelectric inkjet print head and open-air cross-linked with an OmniCure AC475-395 ultraviolet LED source. The principal film precursor was then subjected to the heat-treating conditions given in Table 1.

TABLE 1
Flame Perforation Conditions for Comparative
Examples C1-C5 and Examples 1-4

| | | | | C4-C5 and |
|---|---|---|---|---|
| Example | C1 and 1 | C2 and 2 | C3 and 3 | 4 |
| Film | SBOPP | BOPP | PET | SBOPP |
| Side of film perforated | Matte | Clear | Clear | Clear |
| Normalized flame power | 12,000 | 12000 | 18000 | 12000 |
| (BTU/hr-in.) | | | | |
| Air/fuel control ratio | 10 | 10 | 10 | 10 |
| Burner-to-film gap (mm) | 12 | 12 | 12 | 12 |
| Film speed (m/min) | 20 | 20 | 6 | 30 |
| Backing roller | 45 | 45 | 60 | 60 |
| temperature (° F.) | | | | |
| Backing roller pattern | Circle | Herring- | Herring- | Herring- |
| | | bone | bone | bone |

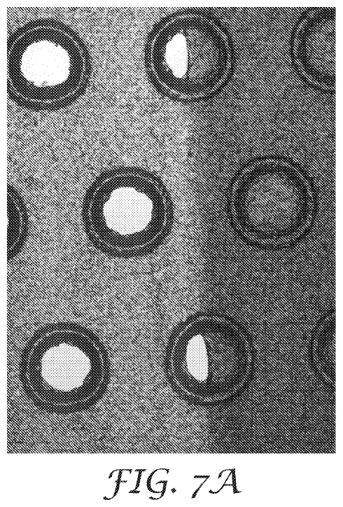

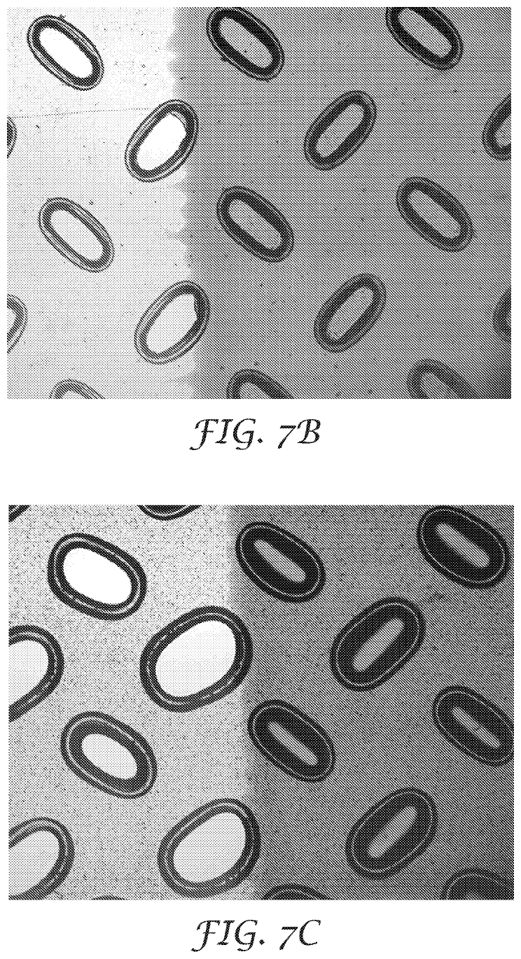

FIG. 7A shows a 5× optical microscopic image of the flame-perforated SBOPP samples showing the line where the SBOPP has closed holes where it is printed and open holes where it is not printed. FIG. 7A shows that the magenta-colored printed area of the film was fully closed while the non-printed area (Comparative Example C1) had open holes. There is a distinct line of open holes starting where the film is not printed.

### Comparative Example C2 and Example 2

The principal film precursor used in this example is a biaxially oriented polypropylene (BOPP) film that does not allow for a closed flame perforation process window as described in patent application WO2016-10551. The same inkjet-coated pattern was applied to this film as in Example 1. The principal film precursor was then flame perforated at conditions given in Table 1 with a herringbone pattern on the backing roller.

FIG. 7B shows a 5× optical microscopic image of the flame-perforated SBOPP samples showing the line where the SBOPP has closed holes where it is printed and open holes where it is not printed. FIG. 7B shows that the magenta-colored printed area of the film had fully closed patterns and the unprinted area (C2) exhibited open holes. There is a distinct line of open holes where the film is not printed.

### Comparative Example C3 and Example 3

The principal film precursor used in this example is a poly(ethylene terephthalate) (PET) film. The same inkjet-coated pattern was applied to this film as in Examples 1 and 2. The principal film precursor was then flame-perforated at conditions given in Table 1 with a herringbone pattern on the backing roller. FIG. 3 shows that the magenta-colored printed area of the film was fully closed and the unprinted area (C3) had open holes. There is a distinct line of open holes where the film is not printed.

FIG. 7C shows a 5× optical microscopic image of the flame-perforated PET film showing the line where the SBOPP has closed holes where it is printed and open holes where it is not printed. FIG. 7C shows that the magenta-colored printed area of the film was fully closed while the non-printed area (Comparative Example C1) had open holes. There is a distinct line of open holes starting where the film is not printed.

### Comparative Examples C4 and C5 and Example 4

For these Comparative Examples and this Example, UV-curable (UV-1) and non-UV cured 0.625% silicone-acrylate (Si-Ac) Low Adhesion Back-size (LAB) formulations were coated on an SBOPP film (7282G film made at Greenville 17J) using the slot-die coating method, to form a principal film precursor. Table 2 shows the formulation for the UV-1 LAB coated in Example 4.

TABLE 2
Formulation for UV-curable LAB Coated on SBOPP Film

| UV-1 | Mass, g | Wt. % | Mass, g |
|---|---|---|---|
| RC711 | 10 | 9.95% | 79.60 |
| CN9009 | 55 | 54.73% | 437.81 |
| SR531 | 35 | 34.83% | 278.61 |
| Irgacure 1173 | 0.5 | 0.498% | 3.98 |

The following composition of UV-curable LAB formulation was made from commercially available raw materials: tight release silicone and anchorage component, Evonik RC711 from Evonik Corp. (Parsippany, N.J.); aliphatic urethane acrylate oligomer, Sartomer CN9009 from Arkema Group (King of Prussia, Pa.); monofunctional acrylate monomer, Sartomer, SR531 from Arkema Group (King of Prussia, Pa.); and UV photo initiator, Irgacure 1173 from Ciba Specialty Chemicals, Inc. (Tarrytown, N.Y.). Table 3 shows the conditions used for coating the LAB formulations. Sample UV-1 LAB was cured using a 300 Watt Fusion UV chamber with a H bulb UV source from Heraeus Noblelight (Buford, Ga.).

TABLE 3
LAB Coating Conditions for LAB coating on SBOPP at the PPDF

| | | Target | | Wet | Line | Coating | Flow |
|---|---|---|---|---|---|---|---|
| | | Thickness | Solids | Thickness | Speed | Width | Rate |
| Sample | LAB | μm | % | μm | ft/min | in. | cc/min |
| TN180412-3 | Si—Ac | 4.5 | 20 | 22.50 | 10 | 8 | 13.94 |
| TN180412-6 | UV-1 | 4.5 | 20 | 22.50 | 10 | 8 | 13.94 |

The principal film precursor film construction was then subjected to flame-impingement heat treatment at the conditions stated in Table 1. FIG. 4 illustrates the “cateyes” pattern of modification zones of the heat-treated principal films of examples C4, C5 and 4.

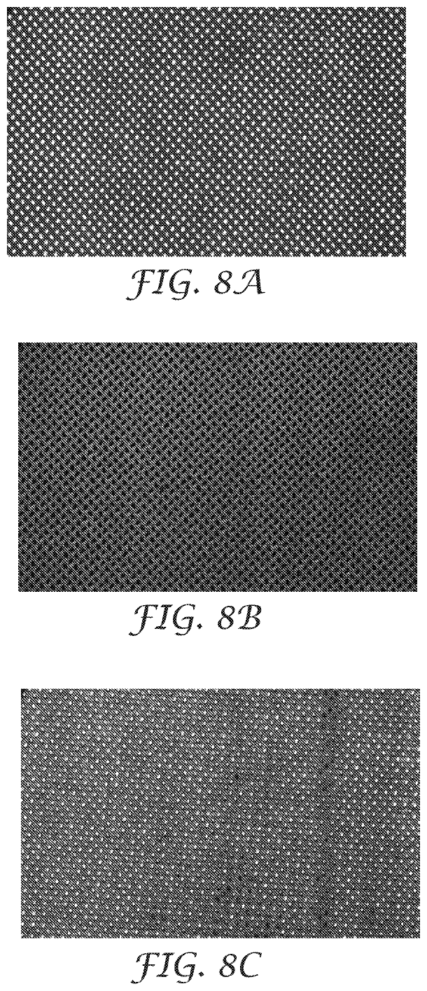

As seen from FIGS. 8A, 8B and 8C, the coated sample with the 4.5μ LAB coating UV cross-linked material remained fully closed after exposure to the flame, the 4.5μ LAB coating that was not UV cross-linked exhibits mostly open holes and the film that has no coating has entirely completely open holes. Example 4 is a demonstration of the invention with a coating method different from digital inkjet printing. Comparative Example C5 shows that the coating needs to be cross-linked to get the desired effect in the flame-impingement (flame perforation) process.

FIG. 4 illustrates the “cateyes” pattern of modification zones of the heat-treated principal films of examples C4, C5 and 4.

### Summary of the Results

Table 4 summarizes all the Examples described in this submission. Examples C1-C3 and 1-3 demonstrate that UV cross-linked multi-functional acrylate coatings can allow closed perforation of different films (BOPP, SBOPP and PET) that normally tend to create open holes at the same flame-perforation process conditions. Example C4 and 4 along with Examples C1-C3 and 1-3 demonstrate that different coating methods and different chemistries (slot-die, digital inkjet) could be used to deposit the thin cross-linked coatings on the films. Example C5 shows that the coating needs to be UV cross-linked to impart the desired properties in the flame-impingement process.

TABLE 4
Summary of Examples C1-C5 and 1-4

| | | | | Coating | UV- | |
|---|---|---|---|---|---|---|
| | | | Coating | Thickness | cross- | Closed |
| Example | Coating | Substrate | Method | (μm) | linking | Perforation |
| C1 | None | SBOPP | NA | NA | NA | No |
| 1 | Multi- | SBOPP | Digital | 1 to 3 | Yes | Yes |
| | functional | | inkjet | | | |
| | acrylate ink | | | | | |
| C2 | None | BOPP | NA | NA | NA | No |
| 2 | Multi- | BOPP | Digital | 1 to 3 | Yes | Yes |
| | functional | | inkjet | | | |
| | acrylate ink | | | | | |
| C3 | None | PET | NA | NA | NA | No |
| 3 | Multi- | PET | Digital | 1 to 3 | Yes | Yes |
| | functional | | inkjet | | | |
| | acrylate ink | | | | | |
| C4 | None | SBOPP | NA | NA | NA | No |
| 4 | UV-curable | SBOPP | Slot-die | 4.5 | Yes | Yes |
| | LAB | | | | | |
| C5 | Si—Ac LAB | SBOPP | Slot-die | 4.5 | No | No |

Reference throughout this specification to “one embodiment,” “certain embodiments,” “one or more embodiments” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus, the appearances of the phrases such as “in one or more embodiments,” “in certain embodiments,” “in one embodiment” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments.

While the specification has described in detail certain exemplary embodiments, it will be appreciated that those skilled in the art, upon attaining an understanding of the foregoing, may readily conceive of alterations to, variations of and equivalents to these embodiments. Accordingly, it should be understood that this disclosure is not to be unduly limited to the illustrative embodiments set forth hereinabove. In particular, as used herein, the recitation of numerical ranges by endpoints is intended to include all numbers subsumed within that range (e.g., 1 to 5 includes 1, 1.5, 2, 2.75, 3, 3.80, 4 and 5). In addition, all numbers used herein are assumed to be modified by the term “about.”

Furthermore, all publications and patents referenced herein are incorporated by reference in their entirety to the same extent as if each individual publication or patent was specifically and individually indicated to be incorporated by reference. Various exemplary embodiments have been described. These and other embodiments are within the scope of the following claims.

1. An article comprising:
an oriented heat-treated principal film comprising one or more (co)polymers, capable of thermally-induced self-forming and exhibiting a relaxation temperature (Tᵣ), the oriented heat-treated principal film having first and second major faces, a land portion and one or more modification zones on the second major face, wherein each modification zone comprising a central closed portion and a rim portion surrounding the central closed portion and being surrounded by the land portion, wherein an average thickness of each rim portion is greater than an average thickness of the land portion surrounding the central closed portion, further wherein an average thickness of each central closed portion is less than the average thickness of the land portion surrounding the central portion; and
a cross-linked carrier layer in contact with the first major face.

2. The article of claim 1, wherein each rim portion has a geometric shape selected from a circle, an ellipse, or a combination thereof.

3. The article of claims 1, wherein the cross-linked carrier layer comprises a cross-linked (co)polymer.

4. The article of claim 3, wherein the cross-linked (co)polymer is obtained by cross-linking one or more multi-functional monomers, oligomers, pre-polymers, or a combination thereof.

5. The article of claim 4, wherein the cross-linked (co)polymer comprises a (meth)acrylate (co)polymer.

6. The article of claim 1, wherein the cross-linked carrier layer has a thickness of from 2 micrometers to 50 micrometers.

7. The article of claim 1, wherein the average thickness of the land portion of the heat-treated principal film is about 0.5 to about 3 mils (12 to 75 microns).

8. The article of claim 1, wherein the heat-treated principal film has a tear strength of about 70 g_{f}/mil-thickness or less in the one or more modification zones.

9. The article of claim 1, wherein the one or more (co)polymers is selected from the group consisting of a polyolefin (co)polymer, a polyester (co)polymer, polystyrene, a polyamide copolymer, or a combination thereof.

10. The article of claim 9, wherein the polyolefin (co)polymer is selected from the group consisting of
biaxially oriented polypropylene (BOPP), simultaneously biaxially oriented polypropylene (SBOPP), ethylene acrylic acid copolymer and combinations thereof.

11. The article of claim 1, further comprising an adhesive layer on at least one of the first major face of the heat-treated principal film, or the cross-linked carrier layer, optionally wherein adhesive layer comprises a pressure sensitive adhesive.

12. A method for forming a heat-treated oriented principal film, the method comprising the steps of:
(a) providing an oriented principal film precursor capable of thermally-induced self-forming and having opposed first and second major faces, the principal film precursor comprising one or more (co)polymers and exhibiting a relaxation temperature (Tᵣ);
(b) forming on the first major face of the principal film precursor a layer of a cross-linkable (co)polymer precursor;
(c) exposing the cross-linkable (co)polymer precursor to a source of actinic or ionizing radiation for a time sufficient to form a cross-linked (co)polymer layer;
(d) overlaying at least one female depression in a patterning surface with at least one modification zone of the principal film precursor and the cross-linked (co)polymer layer;
(e) heating the principle film precursor in the at least one modification zone overlaying the at least one female depression in the patterning surface to a temperature above the Tᵣ, while maintaining a temperature of a land portion on the second major face of the principal film precursor surrounding the at least one modification zone below the Tᵣ, so as to cause dimensional modification of the principal film precursor within the at least one modification zone, thereby forming a heat-treated principal film; and
(f) cooling the at least one modification zone to a temperature below the Tᵣ, wherein each modification zone of the heat-treated principal film comprises a central closed portion and a rim portion surrounding the central closed portion and being surrounded by the land portion, wherein the average thickness of each rim portion is greater than the average thickness of the land portion surrounding the modification zone, further wherein the average thickness of each central closed portion is less than the average thickness of the land portion surrounding the modification zone.

13. The method of claim 12, wherein forming comprises vapor coating, solvent-coating, waterbased coating, 100% solids coating, or a combination thereof.

14. The method of claim 12, wherein the source of actinic or ionizing radiation is selected from the group consisting of ultraviolet radiation, infrared radiation, thermal radiation, electron beam radiation, gamma radiation, or a combination thereof.

15. The method of claim 12, wherein the differential heating is carried out using flame impingement or selectively directed infrared radiation.
